(19) United States
(12) Patent Application Publication
(10) Pub. No.: US 2010/0232839 A1
(43) Pub. Date: Sep. 16, 2010

(54) Image forming system

(75) Inventor: Daichi Yamaguchi, Sagamihara-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/659,178

(22) Filed: Feb. 26, 2010

(30) Foreign Application Priority Data
Mar. 13, 2009 (JP) 2009-060731
Dec. 2, 2009 (JP) 2009-274121

(51) Int. Cl. G03G 15/08

(52) U.S. Cl. 399/254; 399/258; 399/279; 399/255

(57) ABSTRACT

A developing unit, which incorporates a developer carrier and can be used in an image forming apparatus incorporated in an image forming system, includes an agitator to agitate a developer including a toner therein, a toner conveyer to convey the developer agitated by the agitator, and a developer carrier disposed facing an image carrier at a development area located between the developer carrier and the image carrier to carry the agitated developer conveyed by the toner conveyer toward a surface thereof to develop a latent image formed on the image carrier into a toner image with the developer at the development area. An adhesion force exerted between the surface of the developer carrier and a toner particle is 100 nN or smaller. The developing unit further includes a supplementary particle supplier and a developer container to mix supplementary particles with the developer therein.

### CROSS-REFERENCE TO RELATED APPLICATIONS

The present patent application claims priority pursuant to 35 U.S.C. §119 from Japanese Patent Application No. 2009-060731, filed on Mar. 13, 2009 in the Japan Patent Office, and Japanese Patent Application No. 2009-274121, filed on Dec. 2, 2009 in the Japan Patent Office, which are hereby incorporated by reference herein in their entirety.

### BACKGROUND OF THE INVENTION

1. Field of the Invention

Example embodiments of the present patent application generally relate to an image forming system, and more particularly, to a developing unit incorporating a developer carrier, an image forming apparatus incorporating the developing unit, and toner used in developer used to develop images.

2. Discussion of the Related Art

Known developing units, each of which can be incorporated in an image forming apparatus, develop a latent image formed on a surface of a photoconductor into a visible toner image with single-component or one-component developer consisting essentially of toner. Structurally, such developing units generally include a developing roller disposed facing the photoconductor, a developer regulating member, and a developer supplying roller. The latter two are disposed in contact with the developing roller.

In such developing units, the developer or toner contained in the developing unit is frictionally charged while the developing roller and the developer supplying roller are slidably rotated in contact with each other and supplied to the developing roller. The toner, which is electrically held on the surface of the developing roller, is regulated (that is, evened out) by the developer regulating member to an even thin layer that is electrically charged to a desired value. Then, in a development area of the developing unit where the photoconductor and the developing roller face each other, the toner electrically held on the surface of the developing roller is transferred by a development electric field onto a latent image formed on the photoconductor so that the latent image is developed into a visible toner image.

Residual toner remaining on the surface of the developing roller and left unused for development in the development area and is scraped from the surface of the developing roller at a contact part with respect to the developer supplying roller. As the developer supplying roller rotates, new toner is supplied to the surface of the developing roller. Meanwhile, the residual toner scraped by the developer supplying roller is mixed with toner contained in the developing unit as the developer supplying roller rotates.

Failure to remove the residual toner left unused on the surface of the developing roller can accelerate deterioration of the toner. For example, the residual toner can be repeatedly subjected to mechanical stress large enough to degrade toner charge characteristics. Deterioration of the toner can abet so-called toner filming on the surface of the developing roller, which can result in poor chargeability on the surface of the developing roller and poor retention of toner on the surface of the developing roller. Such filming is likely to cause unevenness and/or white streaks in the formed images, which can greatly adversely affect image quality.

These drawbacks occur not only in known developing units using single-component toner but also in known developing units using two-component developer. Such two-component developing units are now described in greater detail.

Image forming apparatuses carry out a fixing process in which toner on an image is fixed to a transfer sheet using, among other parts, a fixing roller. Typically, wax is applied to the fixing roller in this process to facilitate fixing of the toner. In order to reduce the number of parts and components of image forming apparatuses in recent years, however, such application of wax to the fixing roller in the fixing process is now often done by the toner, in which case, toner that contains a wax compound inside the toner particles is used. Wax-containing toner particles are easy to adhere to the surface of a developing roller, however, and therefore toner filming can occur on the surface of the developing roller easily. Further, the size of the toner particles has been reduced to achieve higher image quality, but the smaller the diameter of the toner particle, the greater the mechanical stress applied per unit volume of toner, thus accelerating toner deterioration. Such degraded toner tends to adhere to the surface of the developing roller more easily, again causing toner filming on the surface of the developing roller.

To eliminate such drawbacks, it is desirable to enhance toner releasability to cause toner to release from the surface of the developing roller and to prevent toner filming on the surface of the developing roller. More specifically, by optimizing surface roughness or surface energy of the surface of the developing roller, it is frequently tried to enhance the toner releasability.

The following describes related-art techniques proposed to prevent toner filming on the surface of a developing roller in a developing system using single-component developer.

There are two general approaches: One technique is to improve the developing roller and the other is to improve conditions other than those of the developing roller.

JP-2002-351133-A discloses a fine toner ratio in toner particles used for image forming is limited. The effect, however, is limited since the diameter of a toner particle has been gradually decreasing recently.

Meanwhile, JP-H08-044169-A discloses a sealing member provided below a developing roller. In this technique, toner remaining on the surface of the developing roller is collected easily by applying a discharge voltage to the sealing member. However, the electric discharge of residual toner is not easy, and further can cause a decrease in discharging efficiency especially at a portion where multiple layers of toner overlap. Therefore, the effect is also limited.

By contrast, numerous techniques have been proposed to prevent toner filming by changing the characteristics of a developing roller itself. More specifically, toner releasability with respect to the surface of the developing roller is improved to prevent toner particles from adhering to the surface of the developing roller easily.

JP-2006-227447-A proposes preventing toner filming on the surface of a developing roller by regulating surface roughness of the developing roller using a silicone compound as a member to form the surface of the developing roller. In addition, JP-H11-282248-A proposes preventing toner filming on the surface of a developing roller by employing a compound of rubber and resin material, to which toner particles are difficult to adhere, for surface of the developing roller. JP-H11-282248-A is supposed to achieve a reduction in a coefficient of friction of the surface of the developing roller.

However, the effects of these proposals are also limited and none of them has achieved any fundamental solution. There are two main reasons.

One of these reasons is that the ultimate target releasability for toner to release from the surface of the developing unit is only indirectly evaluated and manipulated. It is true that toner releasability is affected by surface roughness and coefficient of friction, however, details of specific values and specific states or conditions to enhance the toner releasability have not been shown. For example, it is not clearly disclosed which values, those of the roller surface or the particle surface, contribute to enhance toner releasability and in what degree.

For example, JP-H11-282248-A discloses a technique to maintain the surface of the developing roller at a low coefficient of friction so as to achieve a reduction in the frequency of toner filming. However, the coefficient of friction is greatly affected by the target of friction and therefore cannot always be conducive to good toner releasability from the surface of the developing roller.

The other reason is that the methods used and evaluations obtained are macroscopic. Even if the condition of the surface of the developing roller is basically good for toner releasing but with some localized areas in poor condition, the poor area(s) on the surface of the developing roller can trigger toner filming. Details of this point are described below, focusing on the coefficient of friction.

Euler's method is generally known as a measurement method of coefficient of friction. When coefficients of friction of the surface of a developing roller are measured using Euler's method, a sheet of paper is wound around the surface of the developing roller. Then, a weight is attached to and hung from one corner of the sheet of paper and the sheet is wound up at a constant speed. When the sheet starts moving, the load applied to the sheet is read. The load value reading thus obtained is converted using a conversion formula into a coefficient of friction of the surface of the developing roller.

In general, when measuring coefficients of friction, as Euler's method described above, coefficients of friction are measured over an averaged surface state of an area of a member that is far greater than an area of the member where one toner particle contacts. However, a surface state of the contact area, for example, over some square μm, and a surface state of the large area of a member, for example, over some square μm, are not exactly the same. For example, even if the surface state of the entire part of the large area of the member is uneven and has irregularities, the surface of the entire contact area has irregularities and is undulated. Therefore, the obtained coefficient of friction is different from the actual coefficient of friction with respect to one toner particle at the contact area. Consequently, even if the coefficient of friction at the large area of the member is small, the coefficient of friction is different from the coefficient of friction at the contact area where the toner particle actually contacts. Accordingly, it is difficult to determine the toner releasability of the surface of the developing roller accurately based solely on the coefficient of friction.

Thus, regarding the surface roughness of the developing roller, for the above-described reasons it is difficult to determine the releasability of toner from the surface of the developing roller adequately simply from the surface roughness of the developing roller.

Therefore, even though the coefficient of friction of the surface of the developing roller and/or the surface roughness of the developing roller is controlled, toner filming on the surface of the developing roller is still likely to occur.

### SUMMARY OF THE INVENTION

Example aspects of the present patent application have been made in view of the above-described circumstances.

Example aspects of the present patent application provide a developing unit that can incorporate a developer carrier that can effectively prevent toner filming by specifying adhesion forces between the surface of a developing roller and each particle of toner.

Other example aspects of the present patent application provide an image forming apparatus that can incorporate the above-described developer unit.

Other example aspects of the present patent application provide an image forming system that can incorporate the above-described image forming apparatus.

In one example embodiment, a developing unit includes an agitator to agitate a developer including a toner therein, a toner conveyer to convey the developer agitated by the agitator, and a developer carrier disposed facing an image carrier at a development area located between the developer carrier and the image carrier to carry the agitated developer conveyed by the toner conveyer toward a surface thereof to develop a latent image formed on the image carrier into a toner image with the developer at the development area. In the developing unit, an adhesion force exerted between the surface of the developer carrier and each particle of the toner is 100 nN or smaller.

The adhesion force may be measured using an atomic force microscope as a measurement instrument.

The toner may have no external additives on the surface of each particle of the toner.

The adhesion force may be obtained as the measurement instrument moves in a grid-like pattern across the surface of the developer carrier at measurement intervals of 1 μm or smaller.

The adhesion force may be obtained by using toner particles each having a diameter within a range of from 3 μm to 10 μm.

The developer carrier may have a roughness of 1 μm or smaller in a vertical direction on the surface thereof, measured as a difference between highest and lowest elevations of the surface of the developer carrier.

Multiple particles each having a diameter of 1 μm or smaller may be distributed over the surface of the developer carrier.

The above-described developing unit may further include a supplementary particle supplier disposed at an upper part thereof to contain supplementary particles each having a diameter of 1 μm or smaller to supply to the surface of the developer. The supplementary particles may be agitated and mixed with the developer in the developing unit before there are conveyed with the developer toward the surface of the developer carrier.

The above-described developing unit may further include a developer container to contain the developer that is supplied to the developer carrier. The supplementary particle supplier may supply the supplementary particles having a diameter 1 μm or smaller to the developer container so as to convey the supplementary particles to the surface of the developer carrier together with the developer.

The developer container may include developer mixed in advance with particles each having a diameter of 1 μm or smaller. The developing unit may further include a developer supplying member to supply the developer to the development area. The developer supplying member may also serve as the supplementary particle supplier.

The supplementary particle supplier may further include a sealing member disposed between the supplementary particle supplier and the developer container to closely block the supplementary particles to travel via a connecting hole that is disposed between the supplementary particle supplier and the developer container. The supplementary particle supplier may communicate with the developer container via the connecting hole by pulling out a part of the sealing member partly protruding out of the developing unit.

The developer container may include developer mixed in advance with particles each having a diameter of 1 μm or smaller. The above-described developing unit may further include a developer supplier to supply the developer to the development area. The developer supplier may also serve as the supplementary particle supplier.

The supplementary particles having a diameter of 1 μm or smaller may be inorganic particles.

The inorganic particles may be silica particles.

The supplementary particles having a diameter of 1 μm or smaller may be resin particles.

Further, in one example embodiment, an image forming apparatus that can incorporate an image carrier to carry a latent image on a surface thereof and the above-described developing unit.

Further, in one example embodiment, an image forming system that can incorporate the above-described image forming apparatus.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic configuration of an image forming apparatus according to an example embodiment of the present patent application;

FIG. 2 is an enlarged view of an image forming unit for yellow toner in the image forming apparatus of FIG. 1;

FIGS. 3A and 3B are diagrams illustrating how to provide irregularity on a surface of a developing roller, formed by an inkjet method;

FIGS. 4A through 4E are schematic diagrams illustrating processes using an inkjet method;

FIG. 5 is a schematic diagram illustrating a surface of a developing roller, applied by a thin film of a functional material;

FIGS. 6A and 6B are schematic diagrams illustrating a line head including multiple heads, extending in an axial direction;

FIG. 7 is a schematic diagram illustrating a surface of a developing roller with irregularity on a surface thereof, formed by a dipping method;

FIG. 8 is a schematic diagram illustrating a surface of a developing roller having unevenness thereon, formed using lithography;

FIG. 9 is a schematic diagram illustrating a surface of developing roller having unevenness thereon, formed using a laser ablation method;

FIG. 10 is a schematic diagram for explaining a developing roller having unevenness thereon, formed using the inkjet method;

FIG. 11 is a schematic configuration of a developing unit according to Example Embodiment 1 of the present patent application;

FIGS. 12A through 12D are diagrams for explaining how to discharge silica particles into a developer case of the developing unit;

FIG. 13 is a diagram of a measurement area of adhesion forces;

FIG. 14 is an image showing a state of the surface of an unused developing roller;

FIG. 15 is an image showing a state of the surface of the developing roller when silica particles are supplied from a silica supplying mechanism to a developer case;

FIG. 16 is an image showing a state of the surface of the developing roller when silica particles are supplied from the silica supplying mechanism to the developer case;

FIG. 17 is a graph showing measurement results of adhesion force of a developing roller when silica particles are supplied from the silica supplying mechanism to the developer case;

FIG. 18 is a graph showing measurement results of adhesion forces exerted on an unused developing roller;

FIG. 19 is a graph showing measurement results of adhesion forces of toner to the developing roller when silica particles are not supplied;

FIG. 20 is a graph showing measurement results of adhesion forces of toner to the developing roller when silica particles are supplied from the silica supplying mechanism to the developer case, with a probe having a toner particle without using external additives being attached at a tip of a cantilever;

FIG. 21 is a schematic configuration of a developing unit according to Example Embodiment 2 of the present patent application;

FIG. 22 is an image showing a state of the surface of the developing roller when silica particles are not supplied;

FIG. 23 is an image showing a state of the surface of the developing roller when silica particles are supplied from the silica supplying mechanism to the developer case;

FIG. 24 is a graph showing measurement results of adhesion forces of toner to the developing roller when silica particles are not supplied from the silica supplying mechanism; and

FIG. 25 is a graph showing measurement results of adhesion forces of toner to the developing roller silica particles are supplied from the silica supplying mechanism to the developer case.

### DETAILED DESCRIPTION OF THE PREFERRED EMBODIMENTS

It will be understood that if an element or layer is referred to as being “on”, “against”, “connected to” or “coupled to” another element or layer, then it can be directly on, against, connected or coupled to the other element or layer; or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would hen be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present patent application.

The terminology used herein is for the purpose of describing particular embodiments only and is not intended to be limiting of the present patent application. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent application is not intended to be limited to the specific terminology so selected and it is to be understood that each specific element includes all technical equivalents that operate in a similar manner.

Referring now to the drawings, wherein like reference numerals designate identical or corresponding parts throughout the several views, example embodiments of the present patent application are described.

Now, example embodiments of the present patent application are described in detail below with reference to the accompanying drawings.

Descriptions are given, with reference to the accompanying drawings, of examples, example embodiments, modification of example embodiments, etc., of an image forming apparatus according to the present patent application. Elements having the same functions and shapes are denoted by the same reference numerals throughout the specification and redundant descriptions are omitted. Elements that do not require descriptions may be omitted from the drawings as a matter of convenience. Reference numerals of elements extracted from the patent publications are in parentheses so as to be distinguished from those of example embodiments of the present patent application.

The present patent application includes a technique applicable to any developing unit, image forming apparatus, and image forming system. For example, the technique of the present patent application is implemented in the most effective manner in an image forming system incorporating an electrophotographic image forming apparatus having a developing unit that uses a developer carrier.

In describing preferred embodiments illustrated in the drawings, specific terminology is employed for the sake of clarity. However, the disclosure of the present patent application is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present patent application are described.

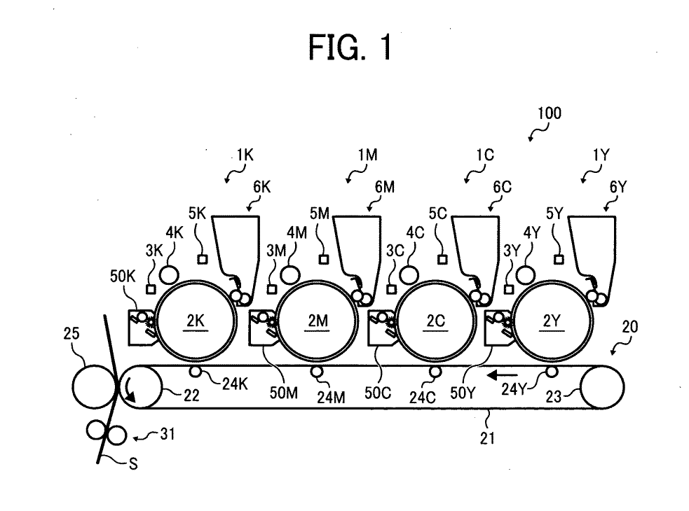

FIG. 1 illustrates a schematic configuration of an image forming apparatus 100 according to an example embodiment of the present patent application.

The image forming apparatus 100 can be any of a copier, a printer, a facsimile machine, a plotter, and a multifunction printer including at least one of copying, printing, scanning, plotter, and facsimile functions. In this non-limiting example embodiment, the image forming apparatus 100 functions as a full-color printing machine for electrophotographically forming a toner image based on image data on a recording medium (e.g., a transfer sheet).

The toner image is formed with four single toner colors, which are yellow, cyan, magenta, and black. Reference symbols “Y”, “C”, “M”, and “K” represent yellow color, cyan color, magenta color, and black color, respectively.

Since units and components with respective suffixes generally have similar configurations to each other, except for the colors of toners, it is also referred to without specific suffixes. At the same time, components and units provided in devices are denoted by common reference numerals without suffixes “Y”, “M”, “C”, and “K” that are generally used to distinguish the colors.

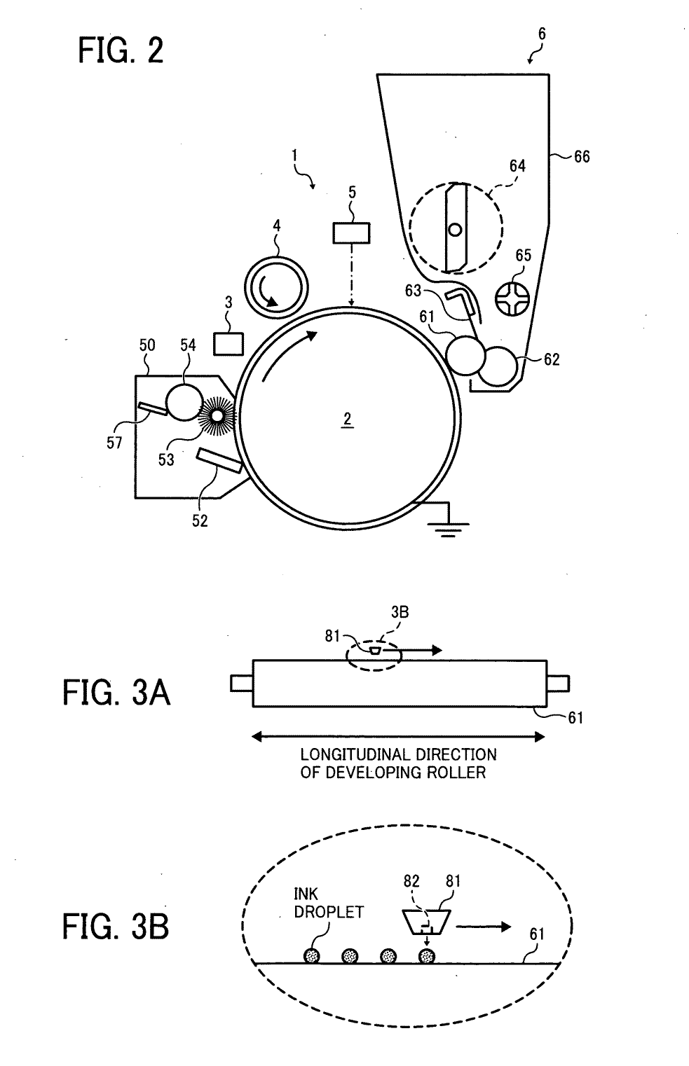

Referring to FIGS. 1 and 2, descriptions are given of an image forming apparatus 100 according to a first embodiment of the present patent application.

FIG. 1 illustrates a schematic configuration of the image forming apparatus 100. The image forming apparatus 100 corresponds to an electrophotographic printer (hereinafter, also referred to simply as “printer” 100 according to the first embodiment of the present patent application.

The printer 100 includes four image processing mechanisms 1Y, 1C, 1M, and 1K, which respectively form yellow (Y), cyan (C), magenta (M), and black (K) toner images. Each of the image processing mechanisms 1Y, 1C, 1M, and 1K have similar structure and functions, except for different toner colors. Accordingly, FIG. 2 illustrates a schematic structure of the image processing mechanism 1, which can be any of the image processing mechanisms 1Y, 1C, 1M, and 1K.

As shown in FIG. 3, the image processing mechanism 1 includes a photoconductor 2, a cleaning unit 50, an electric discharging unit 3, a charging roller 4, an optical writing unit 5, and a developing unit 6. The photoconductor 2Y is rotated by a drive unit, not shown, in a clockwise direction as shown in FIG. 3, and is surrounded by the cleaning unit 50Y, the discharging unit 3, the charging roller 4, the optical writing unit 5, and the developing unit 6 in this order.

The charging roller 4 is disposed in contact with the photoconductor 2 or faces the photoconductor 2 in proximity thereto across a given gap. A charge bias is applied from a charge bias power source, not illustrated, to the charging roller 4 so that the charging roller 4 can uniformly charge a surface of the photoconductor 2 as it rotates in a counterclockwise direction in FIG. 3.

A charging member to charge the photoconductor 2Y is not limited to the charging roller 4. Instead of the charging roller 4, a charging brush can be employed to contact the surface of the photoconductor 2. Further, a charger such as a scorotron charger can be employed as a charging member for uniformly charging the photoconductor 2.

It is desirable that the charging roller 4 has a roller part including a rigid conductive material, faces the photoconductor 2 with a small gap therebetween, and has the following structure. That is, size of the charging roller 4 in an axial direction may be set longer or greater than the maximum width of a printable image, which is approximately 290 mm for a machine processing A4-size sheets.

Further, the charging roller 4 is provided with gap bearings disposed at both ends in the axial direction thereof. The gap bearings serve as an insulating spacer and have a diameter greater than a diameter of a center part of the charging roller 4. With the above-described structure, the charging roller Y contacts the gap bearings disposed at both ends to a non-image forming area arranged at both ends in an axial direction of the photoconductor 2. By so doing, a small gap ranging preferably from approximately 5 μm to approximately 100 μm, and more preferably from approximately 20 μm to approximately 65 μm, can be easily formed between the center portion of the charging roller 4 and the surface of the photoconductor 2. In this example embodiment, the gap is set to 55 μm.

The surface of the photoconductor 2, which has uniformly been charged by the charging roller 4, may be exposed and scanned by light emitted from the optical writing unit 5Y so that an electrostatic latent image for yellow toner can be formed thereon.

The optical writing unit 5 emits a laser light beam or light-emitting diode modulated based on image data sent from an external personal computer, etc.

The developing unit 6 contains single color toner in a developer case 66 serving as a developer container, and supplies single color toner onto the electrostatic latent image formed on the surface of the photoconductor 2 so as to develop the electrostatic latent image into a visible toner image. The toner image is transferred primarily onto an intermediate transfer belt 21, which will be described later.

The cleaning unit 50 removes residual toner from the surface of the photoconductor 2 after primary transfer of the single color toner image onto the intermediate transfer belt 21. The cleaning unit 50 of FIG. 3 includes a cleaning blade 52, a cleaning brush 53, a toner collection roller 54, and a toner collection roller cleaning blade 57.

The cleaning brush 53 is disposed downstream from the cleaning blade 52 in a direction of rotation of the photoconductor 2 and in contact with the surface of the photoconductor 2. The toner collection roller 54 is held in contact with the cleaning brush 53. The toner collection roller cleaning blade 57 is held in contact with the toner collection roller 54 to remove the residual toner.

After the cleaning unit 50 has removed the residual toner from the surface of the photoconductor 2, the electric discharging unit 3 that includes a discharge lamp, not illustrated, electrically discharges the clean surface of the photoconductor 2 for a subsequent image forming operation.

As previously described, the image processing mechanisms 1Y, 1C, 1M, and 1K have similar structures except respective toner colors. Specifically, as shown in FIG. 2, the image processing mechanism 1Y includes a photoconductor 2Y, a discharging unit 3Y, a charging roller 4Y, an optical writing unit 5Y, a developing unit 6Y, a cleaning unit 50Y, and related units and components. Similarly, the image processing mechanism 10 includes a photoconductor 2C, a discharging unit 3C, a charging roller 4C, an optical writing unit 5C, a developing unit 6C, a cleaning unit 50C, and related units and components; the image processing mechanism 1M includes a photoconductor 2M, a discharging unit 3M, a charging roller 4M, an optical writing unit 5M, a developing unit 6M, a cleaning unit 50M, and related units and components; and the image processing mechanism 1K includes a photoconductor 2K, a discharging unit 3K, a charging roller 4K, an optical writing unit 5K, a developing unit 6K, a cleaning unit 50K, and related units and components.

As shown in FIG. 1, the printer 100 further includes a transfer unit 20, four primary transfer rollers 24Y, 24C, 24M, and 24K, a secondary, transfer roller 25, a belt cleaning unit, not illustrated, and a pair of registration rollers 31.

The transfer unit 20 is disposed below the image processing mechanisms 1Y, 1C, 1M, and 1K, and includes the intermediate transfer belt 21 that is loop-shaped and rotates in a counterclockwise direction in FIG. 1.

The intermediate transfer belt 21 is extended by and wound around a drive roller 22 and a driven roller 23, which are disposed inside the loop, and rotates in a counterclockwise direction in FIG. 3 in response to rotation of the drive roller 22.

The four primary transfer rollers 24Y, 24C, 24M, and 24K are disposed in contact with an outer surface of the intermediate transfer belt 21 to sandwich the intermediate transfer belt 21 between the four primary transfer rollers 24Y, 24C, 24M, and 24K and the photoconductors 2Y, 2C, 2M, and 2K, respectively. Accordingly, a primary transfer nip for forming yellow toner image is formed between the primary transfer roller 24Y and the photoconductor 2Y, a primary transfer nip for forming cyan toner image is formed between the primary transfer roller 24C and the photoconductor 2C, a primary transfer nip for forming magenta toner image is formed between the primary transfer roller 24M and the photoconductor 2M, and a primary transfer nip for forming black toner image is formed between the primary transfer roller 24K and the photoconductor 2K. A transfer bias having a polarity opposite to that of the toner is applied to a back side (or inner loop side) of the intermediate transfer belt 21.

In the process of sequentially passing the primary transfer nips with the endless rotation of the intermediate transfer belt 21, yellow toner image, cyan toner image, magenta toner image, and black toner image formed on the photoconductors 2Y, 2C, 2M, and 2K, respectively, are primarily transferred onto an outer surface of the intermediate transfer belt 21. With this transfer operation of the toner images, one color toner image having four single colors overlaid thereon (hereinafter, referred to as a four-color toner image) is formed on the intermediate transfer belt 21.

Outside the loop of the intermediate transfer belt 21, the secondary transfer roller 25 to which a secondary transfer bias that is output by a power source, not illustrated, is applied is disposed. The secondary transfer roller 25 is held in contact with the drive roller 22, which is disposed inside the loop, via the intermediate transfer belt 21 that is sandwiched therebetween so as to form a secondary transfer nip between the secondary transfer roller 25 and the drive roller 22.

A sheet feeding cassette, not illustrated, is set below the transfer unit 20. The sheet feeding cassette accommodates a stack of recording sheets including a recording sheet S atop the stack.

The recording sheet S is fed to a sheet path, not illustrated, at a given timing. When the recording sheet S reaches the pair of registration rollers 31 that is disposed at a far end of the sheet path, the pair of registration rollers 31 guides the recording sheet S between the rollers thereof. On sandwiching the recording sheet S by the rollers thereof, the pair of registration rollers 31 stops its rotation so as to convey the recording sheet S to the secondary transfer nip in synchronization with the four-color toner image formed on the intermediate transfer belt 21.

Due to nip pressure or a secondary transfer electrical field formed between the secondary transfer roller 25 to which the secondary transfer bias is applied and the drive roller 22 that is grounded, the four-color toner image formed on the intermediate transfer belt 21 is secondarily transferred onto the recording sheet S within the secondary transfer nip. Then, the four-color toner image merges with white color of the recording sheet S to form a full-color toner image.

After the recording sheet S has passed through the secondary transfer nip, the intermediate transfer belt 21 may still hold residual toner that has not been transferred onto the recording sheet S. Such residual toner is removed by the belt cleaning unit that sandwiches the intermediate transfer belt 21 with the driven roller 23.

A fixing unit, not illustrated, is disposed above the secondary transfer nip formed by the secondary transfer roller 25. The fixing unit fixes the full-color toner image to a surface of the recording sheet S by application of heat and pressure, which is a known technique used in an electrophotographic image forming apparatus.

Since the yellow toner, cyan toner, magenta toner, and black toner on the photoconductors 2Y, 2C, 2M, and 2K may respectively receive the primary transfer bias that has a polarity opposite thereto at the primary transfer nips, the yellow toner, cyan toner, magenta toner, and black toner are likely to be charged to the opposite polarity. Therefore, regularly charged toner particles and oppositely charged toner particles are mixed in the residual toners remaining on the photoconductors 2Y, 2C, 2M, and 2K.

In the printer 100 having the above-described basic configuration, the four image processing mechanisms 1Y, 1C, 1M, and 1K correspond to and serve as toner image forming mechanisms by which a toner image is formed on a surface of each of the photoconductors 2Y, 2C, 2M, and 2K that can rotate endlessly. Further, a combination of the four image processing mechanisms 1Y, 1C, 1M, and 1K and the transfer unit 20 also serves as a toner image forming mechanism to form the toner image on the surface of the intermediate transfer belt 21 that serves as an image conveying member.

<Toner>

The toner of the present patent application preferably includes an additive contained in a toner particle. Any known additive materials can be used for the present patent application. Specific examples of usable additive materials include, but are not limited to, oxides such as Si, Ti, Al, Mg, Ca, Sr, Ba, In, Ga, Ni, Mn, W, Fe, Co, Zn, Cr, Mo, Cu, Ag, V, and Zr, and composite oxides, etc. Among these, silica, titania, alumina, which are oxides of Si, Ti, and Al, are preferably used. An amount of the additive is preferably from 0.5 parts to 1.8 parts with respect to 100 parts of mother toner particle, and more preferably from 0.7 parts to 1.5 parts with respect to 100 parts of mother toner particle.

The toner is preferably surface-treated with a surface treating agent such as an organic silane compound. Specific examples of the organic silane compounds include, but are not limited to, alkyl chlorosilane derivatives such as methyl trichlorosilane, octyl trichlorosilane, and dimethyl dichlorosilane; and alkyl methoxysilane derivatives such as dimethyl dimethoxysilane and octyl trimethoxysilane. Also, hexamethyl disilazane, silicone oil, and the like can be used.

The process of surface treating a toner is not particularly limited, but well-known methods are applicable. For example, a process involving adding an additive in a solvent(s) containing an organic silane compound, and then drying, a process involving spraying a solvent containing an organic silane compound to an additive, and then drying, and the like can be applied.

The average particle diameter of the toner used for electrophotographic image forming apparatus is preferably from 3 μm to 7 μm.

<Carrier>

As the magnetic carrier C, any known carrier having a particle diameter of from 20 μm to 200 μm such as iron powder, ferrite powder, magnetite powder, magnetic resin carrier, etc. can be used.

The magnetic carrier used in the printer 10 according to the first embodiment of the present patent application has a mean diameter of 55 μm, includes magnetic material such as ferrite in a core material including metal or resin, and has a surface coated with a silicone resin. Specific examples of the coating material of the surface of the magnetic carrier include, but are not limited to, amino resin such as urea-formaldehyde resin, melamine resin, benzoguanamine resin, urea resin, polyamide resin, and epoxy resin; and other resins such as polyvinyl resin, polyvinylidene resin, acrylic resin, polymethyl methacrylate resin, polyacrylonitrile resin, polyacetic acid vinyl resin, polyvinyl alcohol resin, polyvinyl butyral resin, polystyrene resin, and the like. Other specific examples of the coating material of the magnetic carrier include, but are not limited to, polystyrene resin such as styrene acryl copolymer, halogenated olefin resin such as polyvinyl chloride, polyester resin such as polyethylene terephthalate resin and polybutylene terephthalate resin, polycarbonate resin, polyethylene resin, polyvinyl fluoride resin, polyvinylidene fluoride resin, polytrifluoroethylene resin, polyhexafluoropropylene copolymer of vinylidene fluoride and acrylic monomer, copolymer of vinylidene fluoride and vinyl fluoride, fluoroterpolymer such as terpolymer of tetrafluoroethylene and vinylidene fluoride and non-fluoride monomer, silicone resin, and the like.

As needed, the coating material of the magnetic carrier can contain conductive powder. Specific examples of the conductive powder include, but are not limited to, metallic powder, carbon black, titanium oxide, tin oxide, zinc oxide, and the like. These conductive powder preferably include a mean particle diameter of 1 μm or smaller. When the mean particle diameter of the magnetic carrier exceeds 1 μm, the control of electrical resistance may become difficult.

<Developing Unit>

A developing unit is designed to develop an electrostatic latent image formed on a surface of a photoconductor to a toner image. Such developing unit generally includes a developing roller to supply toner to the photoconductor. Since the developing roller transfers toner to a photoconductor, it is not preferable that the developing roller can allow a large adhesion force to be exerted with respect to toner. Therefore, the present patent application can be applied effectively.

To charge the one-component toner frictionally, a developing roller for one-component developer includes a roller part and a metallic axis part. The roller part includes an elastic member having an outer circumference with low friction coefficient such as rubber, etc. The metallic axis part runs in an axial direction through a center of the roller part.

As the elastic member of the developing roller, an elastic rubber, an elastomer and the like applicable to the developing roller may be implemented by one or more of butyl rubber, fluorine-contained rubber, acrylic rubber, EPDM, NBR, acrylonitrile-butadiene-styren rubber, natural rubber, isoprene rubber, styrene-butadiene rubber, butadien rubber, urethane rubber, syndiotactic 1,2-polybutadiene, epichlorohydrine rubber, polysulfide rubber, polynorbornene rubber, thermoplastic elastomer (e.g., polystyrene, polyolefine, polyvinyl chloride, polyurethane, polyamide, polyurea, polyester, or fluorocarbone resin). However, specific example materials of the elastic member of the developing roller is not limited to the above-described materials.

<Developing Roller for Two-Component Developer>

Similar to the developing roller for two-component developer, a developing roller for two-component developer includes a roller part including an elastic member having low friction coefficient, a metallic axis roller that runs in an axial direction through a center of the roller part, and a roller having a metallic surface. Specific examples of the metallic roller may include, but are not limited to, aluminum, nickel, chromium, nichrome, copper, gold, silver, platinum and the like.

A coating material may be provided to a surface of the developing roller appropriately so as to obtain temporal stability in quality. The material coating the developing roller may be chargeable to polarity opposite to the polarity of the toner or to the same polarity as the toner if the developing roller does not function to charge the toner by friction. The material chargeable to polarity opposite to the polarity of the toner is, e.g., a material containing silicone resin, acryl resin, polyurethane resin or rubber. Typical of the material chargeable to the same polarity as the toner is fluorine. Teflon (registered trademark)-based materials containing fluorine have inherently low surface energy and a desirable parting ability, and therefore cause a minimum of filming ascribable to aging to occur.

Specific examples of general resins for use in the surface of the surface coating material include polytetrafluoroethylene (PTFE), tetrafluoroethylene-perfluoroalkylvinylether copolymers (PFA), tetrafluoroethylene-hexafluo-ropropylene copolymers (FEP), polychlorotrifluoroethylene (PCTFE), tetrafluoroethylene-ethylene copolymers (ETFE), chlorotrifluoroethylene-ethylene copolymers (ECTFE), polyvinylidene fluoride (PVDF), polyvinylfluoride (PVF), etc. Carbon black or similar conductive substance is often added to such resins in order to provide them with conductivity. Further, other resins may be mixed thereto in order to provide uniform coating to a developing roller.

Next, a description is given of various methods to give a developing roller, e.g., the developing roller 61, an uneven surface so that the surface of the developing roller 61 has convex and concave portions having a difference between highest and lowest elevations of 1 μm or smaller. These methods are used as a final process after the developing roller is manufactured through the above-described processes.

Vertical projections (such as convex portions and bumps) and recesses (such as concave portions or holes) having a difference between highest and lowest elevations of the surface of the developing roller 61 can be formed by adding bumps or convex portions on the surface thereof and by digging holes or concave portions on the surface thereof. With either method, the surface is finished with these portions at intervals of 500 nm, preferably at intervals of 50 nm, and with the bumps and holes having a difference within a range of from 10 nanometers to 1000 nanometers.

Following descriptions are given of various methods for forming the vertical roughness or convex and concave portions on the surface of the developing roller 61.

[Inkjet Fabrication Technology]

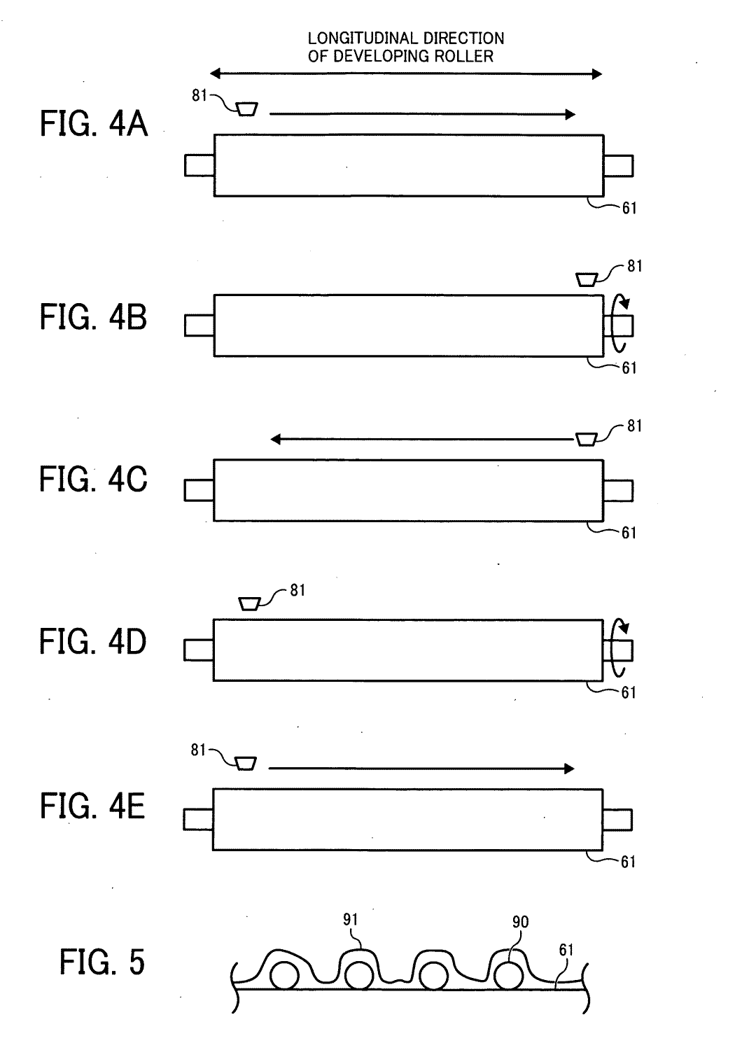

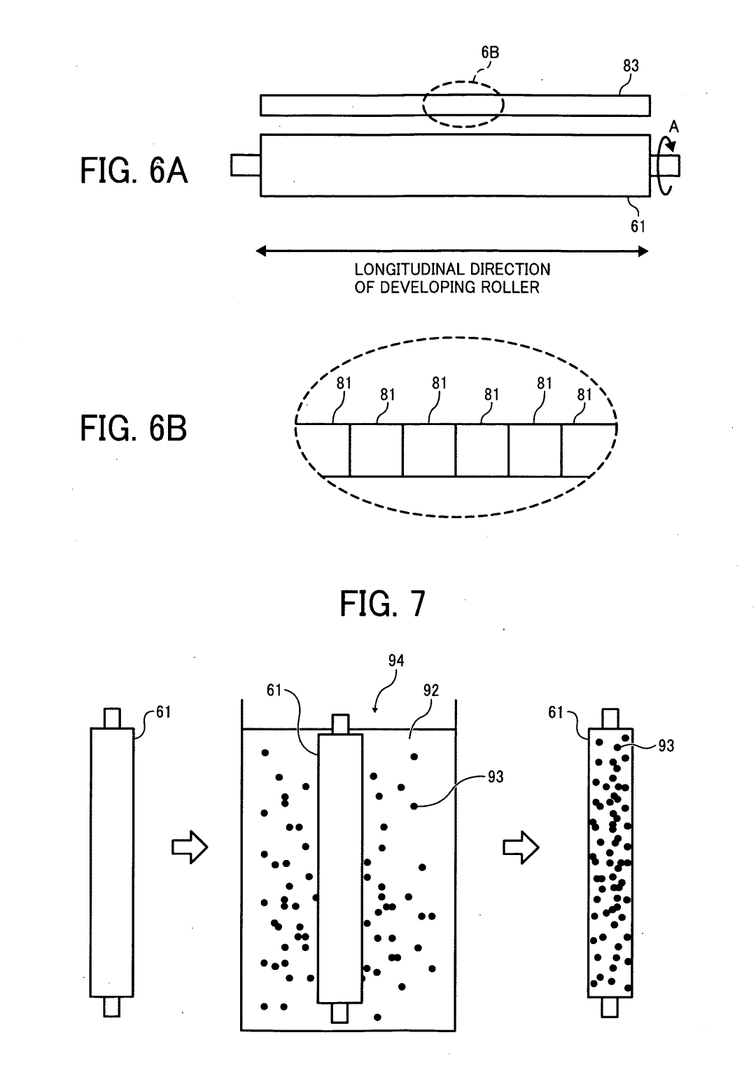

Inkjet fabrication technology is used to give a developing roller, e.g., the developing roller 61, an uneven surface with small bumps thereon by spraying small ink droplets onto the surface of developing roller 61. More specifically, a print head 81 mounted on a nozzle 82 from which ink droplets are ejected is located above the surface of the developing roller 61, as shown in FIGS. 3A and 3B. The inkjet droplets are sprayed onto the surface of the developing roller 61 as the print head 81 moves from a first position at one end in a longitudinal direction or axial direction of the developing roller 61 to a second position at the other end thereof, as shown in FIG. 4A. With this action, multiple small bumps or convex portions are formed on the surface of the developing roller 61. Once the print head 81 arrives at the second position of the developing roller 61 in its longitudinal direction, the developing roller 61 rotates in a circumferential direction, which is a direction indicated by arrow in FIG. 4B. Then, as shown in FIG. 4C, as the print head 81 moves from the second position back to the first position, the ink droplets are sprayed again from the nozzle 82 of the print head 81 over the surface of the developing roller 61 so that multiple small bumps or convex portions are formed over new area of the surface of the developing roller 61. The developing roller 61 then rotates in the circumferential direction again, as shown in FIG. 4D, and the print head 81 moves from the first position to the second position in the longitudinal direction of the developing roller 61, as shown in FIG. 4E. By repeating these actions, small convex and concave portions are made over the entire surface of the developing roller 61 to form an uneven surface of the developing roller 61.

The ink droplets are sprayed over the surface of the developing roller 61 through the nozzle 82 that includes openings having a diameter of from some micrometers [μm] to several tens of micrometers [μm]. The nozzle 82 is connected to a small pressure chamber filled with ink. The ink in the pressure chamber is ejected from the nozzle 82 by generating a significantly great amount of pressure to the pressure chamber. A piezoelectric method using piezoelectric elements and a bulb method using boiling phenomenon by application of heat can be used as a pressure generation source.

Usable ink droplets depend on types of the pressure generation source. For example, ink for the print head 81 using the piezoelectric method is required to have an amount of some tens of millipascal second [mPa·s] or smaller. Other conditions are that ink does not become solidified or produce deposit or precipitate in the print head 81, that ink does not clog due to drying, and the like.

Further, nanometer-sized particles 90 are dispersed in the ink droplets. When nanometer-sized particles 90 include metallic substance, the particles 90 are used by coated by organic substance on the surface of the developing roller 61 because the metallic surface may be active and therefore the nanometer-sized metallic particles 90 tend to aggregate or become massed together. More specifically, the nanometer-sized particles 90 can use Au, Ag, Ni, Mn, SiO₂, and the like having a diameter of from some nanometers [nm] to some tens of nanometers [nm]. The size of these nanometer-sized particles 90 largely affects on an ultimate size of small convex and concave portions formed on the uneven surface of the developing roller 61.

Type of ink can be divided into nonsolvent ink and solvent ink.

The nonsolvent ink does not include volatile solvent and the entire ink functions as a volatile material. Examples of the nonsolvent ink are liquid crystal materials, ultraviolet curable resin, thermosetting resin, and so forth.

For the solvent functional ink, a thin film of functional material 91 can be obtained by dissolving or dispersing functional materials 91 in volatile solvent and drying to remove the solvent, as shown in FIG. 5.

Further, to shorten a period of processing for forming the convex and concave portions on the surface of the developing roller 61, multiple print heads 81 are provided at same pitches of bumps or convex portions formed by ink droplets on the surface of the developing roller 61 to form a long line head 83 where the multiple print heads 81 are arranged in an array along the width of the longitudinal direction of the developing roller 61, as shown in FIGS. 7A and 7B. With the configuration, the bumps or convex portions can be formed on the surface of the developing roller 61 without causing the print head 81 to move in the longitudinal direction of the developing roller 61. That is, without the movement of the print head 81, ink droplets are sprayed through the nozzle 82 over the surface of the developing roller 61 while rotating the developing roller 61 in a circumferential direction thereof. Thus, when the multiple print heads 81 are arranged in a width direction or longitudinal direction of the developing roller 61, manufacturing cost for manufacturing the multiple print heads 81 increases but a processing period of time to process the developing roller 61 can decrease. Therefore, this method may be advantageous when mass-production of the developing roller 61 can be expected.

[Dipping Method]

Uneven surface can also be formed on a developing roller, e.g., the developing roller 61, by forming convex portions using a dipping method. In the dipping method, as shown in FIG. 7, the developing roller 61 is dipped in solution 94 in which nanometer-sized particles 93, hereinafter “nanoparticles 93”, are dispersed in solvent 92, and then is pulled out from the solution 94 and dried. With these processes, the developing roller 61 can obtain an uneven surface with small convex portions over the entire surface of the developing roller 61 in one attempt.

Although the pitches of bumps or convex portions formed on the surface of the developing roller 61 cannot be controlled sufficiently when compared with the inkjet method, the dipping method may not need to repeatedly move the print head 81 in the longitudinal direction of the developing roller 61, and thus can reduce the processing period.

The dipping method can basically use the solvent 92 and nanoparticles 93 that are identical to those used in the inkjet method. In the dipping method, the pitches of the small convex and concave portions formed on the surface of the developing roller 61 depend on viscosity of the solvent 92 and concentration of the nanoparticles 93 mixed with the solvent 92. Further, unevenness or nonuniformity of the surface of the developing roller 61 after processing is affected by the state of nano-order dispersion of the nanoparticles 93 in the solution 94. Therefore, it is necessary to stir or agitate the solution 94 sufficiently and control a period of time to dip the developing roller 61 into the agitated solution 94 substantially.

[Lithographic Technology]

A method using lithographic technology can also be used to give a developing roller, e.g., the developing roller 61 an uneven surface with small convex and concave portions thereon.

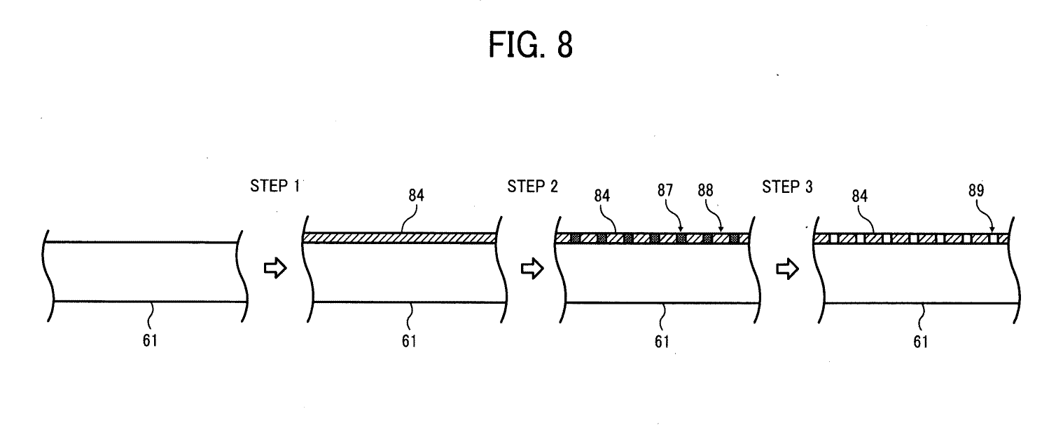

FIG. 8 illustrates a cross-sectional view in a longitudinal direction of the developing roller 61. Specifically, the surface of the developing roller 61 is coated by photosensitive resin (photoresist or resist) 84 at step 1 in FIG. 8, and exposed to a radiation source of a specific wavelength so that the chemical resistance of the resist to solution changes at step 2 in FIG. 8. By removing changed regions (exposed regions) 87 of the photosensitive resin or resist 84 by a solvent at step 3, concave portions 89 are formed on the resist 84 to provide an uneven surface to the developing roller 61 with small convex and concave portions on the surface thereof. Alternatively, small convex and concave portions can be formed on the surface of the developing roller 61 by removing unchanged regions (unexposed regions) 88 of the resist 84. The method in which the changed regions (exposed regions) 87 are etched away by the solvent and the unchanged regions (unexposed regions) 88 are resilient is called a positive-type method, and by contrast, another method in which the changed regions (exposed regions) 87 are resilient to the solvent and the unchanged regions (unexposed regions) 88 are etched away is called a negative-type method.

Example materials of the positive photosensitive resins (resist) 84 are naphtoquinone diazide compounds such as trihydroxybenzophenone, tetrahydroxybenzophenone, and 6-diazo-5,6-didydro-5-oxo-1-naphthalenesulfonic acid, and example materials of the negative photosensitive resins (resist) 84 are bis-azido compounds. The material that is actually used for forming the developing roller 61 is determined based on affinity between materials used for the top layer of the developing roller 61 and the resist 84. Generally, when emphasizing smoothness, a spin coater is used to apply the resist 84 to a flat substrate such as semi-conductor and Micro Electro Mechanical Systems (MEMS). In an example embodiment of the present patent application, however, a layer of the resist 84 is deposited on the surface of the developing roller 61 by using the dipping method in which the developing roller 61 is dipped in a tank for a predetermined time or a spray by spraying the resist 84 directly to the surface of the developing roller 61.

Accurate patterning of photoresist during a lithography process is affected by an exposure source. When forming convex and concave portions having a size of submicron to nano-order scale, as shown in the example embodiment of the present patent application, it is necessary to use ArF laser, F2 laser, extreme ultraviolet (EUV), and electron beam. In general, mask pattern having a size of a pattern to be processed is used during exposure. By contrast, regardless of a long exposure time, electron beam lithography can perform the patterning process without using mask patterns.

Examples of solutions used to remove the photoresist 84 after exposure are KOH, tetra methyl ammonium hydroxide (TMAH), NH4F.HF.H2O aqueous solution, HF.H2O aqueous solution, and the like. Specific solution depends on type of material of the photoresist 84. Further, even a very small amount of solution remains on the surface of the developing roller 61 after removal of the photoresist 84, toner held on the surface of the developing roller 61 in an actual machine can melt due to the residual solution. Therefore, it is crucial to remove the surface of the developing roller 61 by rinsing with special liquid or pure water after the removal of the photoresist 84.

[Laser Ablation]

Laser ablation can also be used to give a developing roller, e.g., the developing roller 61 an uneven surface with small convex and concave portions over the surface thereof. Laser ablation is a process of boring or digging a target substrate or object material by irradiating it with a laser beam and dissolving the surface of the material thermally or chemically and drying the dissolved fragment. The laser ablation has a feature that enables the formation of convex and concave portions on the surface of the developing roller 61 in a single process, in other words, without performing the development, exposure, and drying processes as the above-described lithography.

Laser ablation has been developed and performed using various light sources. When forming convex and concave portions having a size of submicron on the surface of a developing roller 61, like in an example embodiment of the present patent application, it is important that thermal diffusion due to laser emission is reduced or prevented as possible. To prevent the thermal diffusion, a shorter pulse length is advantageous.

A recent study found that, when irradiating at a low fluence (energy density) that is close to a threshold to cause ablation using a femto-second laser, a nano-scale periodic structure with very small pitches having 1/10 to ⅕ of laser wavelength can be build, and a nanometer order process for particles having some tens of nanometers [nm] can be substantially possible.

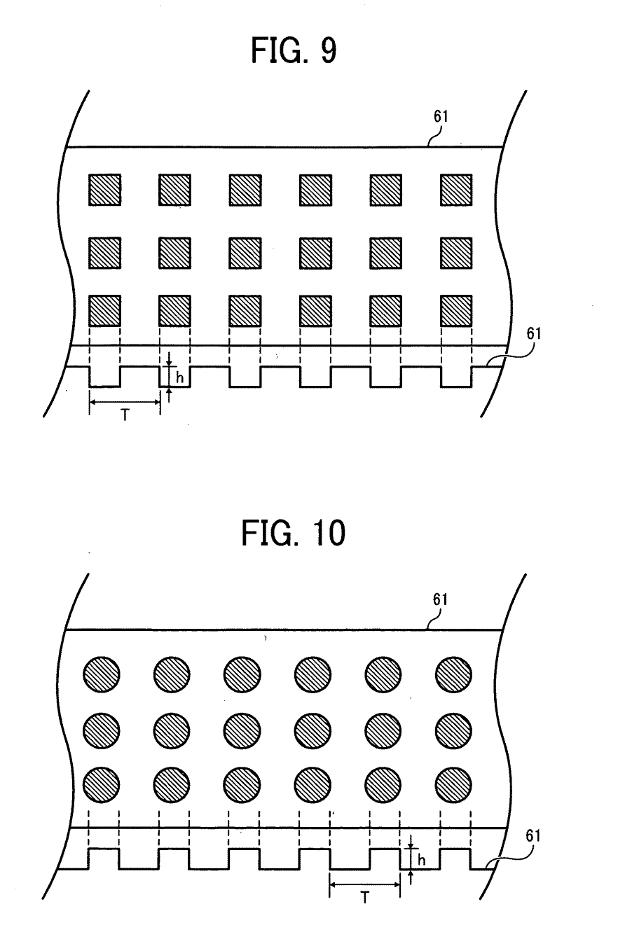

The order of processes or methods for forming small convex and concave portions on the surface of a developing roller with laser ablation is substantially same as that of processes with the inkjet technology method. That is, the laser ablation repeats the processes of boring or digging given portions at predetermined pitches on the surface of the developing roller 61 along the longitudinal direction thereof, rotating the developing roller 61 in the circumferential direction, and digging different given portions on the surface of the developing roller 61. However, the lithography is different from the inkjet method in the following processes. That is, the lithography provides an uneven surfaces of the developing roller 61 by digging the surface thereof to form convex and concave portions, as illustrated in FIG. 9, while the inkjet method sprays ink droplets to deposit bumps or convex portions of ink on the surface of the developing roller 61, as illustrated in FIG. 10. However, conditions of time “T” of pitch of each convex and concave portion and height “h” of each convex and concave portion are same as those of the inkjet method.

Recently, image forming apparatuses such as electrophotographic copiers and laser printers have been developed remarkably in various points, for example, enhancement in image quality, an increase in printing speed, and downsizing of mechanical apparatuses. The electrophotographic method uses photoconductive material to perform an exposure process or a process to form a latent image electrically on a surface of a photoconductor, a developing process or a process to develop the latent image with toner, a process to transfer a toner image formed on a recording medium such as a sheet of paper, and a fixing process or a process to fix the toner image by applying heat by a fixing roller. Especially, the developing process is directed to image forming and is substantially important in high-functional image forming apparatus.

Known developing methods that are generally used in electrophotography are a method using one-component developer including toner and another method using two-component developer including toner and carrier.

In the method using one-component developer, toner particles are supplied onto the surface of a developing roller, and a toner regulating member regulates the thickness of layer of the toner particles while frictionally charging the toner particles. In a development area where the developing roller and the image carrier face each other, an electrostatic latent image formed on the image carrier is developed electrically with the toner regulated in the thin layer into a toner image. However, to develop a high-quality toner image having a given image density, a large amount of sufficiently charged toner may need to be conveyed to the development area.

By contrast, the method using two-component developer can provide an appropriate charging amount to toner by agitating toner particles together with carrier particles. In this method, a developing roller including a magnetic roller and a rotatable non-magnetic development sleeve wound around the magnetic roller carries the two-component developer to an image carrier so as to develop an electrostatic latent image formed on the image carrier. Carrier particles employed in this method are used to charge and convey toner particles, and it is known that a mixing ratio and agitation state of carrier particles and toner particles significantly affect image forming.

One of constant issues both of these methods for developing images have is contamination on the surface of a developing roller and of a carrier particle to hold toner particles thereon. Since the developing roller and carrier particles slidably contact toner particles constantly while the image forming apparatus is operating, toner component can adhere fixedly to the surface of the developing roller and/or the surface of the carrier particles. In such a condition, the developing roller and/or the carrier particles cannot charge the toner particles sufficiently, which are original characteristics thereof. When the condition becomes worse, the developing roller and/or the carrier particles cannot even hold the toner particles thereon. As a result, defective images having image nonuniformity and white streaks on a solid image can be produced.

Such a phenomenon that can contaminate the surface of the developing roller and the surface of the carrier is called “toner filming”. Because of a recent trend in toner development, toner filming has been a big issue.

One reason that causes the drawbacks is use of toner containing wax compound. In recent years, in order to reduce the number of parts and components in an image forming apparatus, it is becoming that wax is applied to a fixing roller via toner in a fixing process in which toner on an image is fixed to a transfer sheet, and therefore toner that containing a wax compound inside a toner particle is used. Since wax has a relatively small molecular weight, viscosity thereof is also small. Therefore, the surface of the developing roller and the surface of the carrier particles can be contaminated more easily than other resin materials.

Further, a reduction in size of a toner particle can be pointed as another reason to cause the drawbacks. The size of a toner particle has been gradually reduced to achieve high image quality. However, the toner particles having a smaller diameter can apply a greater stress with respect to each toner particle per unit volume, which can speed up deterioration of toner. Therefore, such degraded toner tends to adhere to the surface of the developing roller and the surface of the carrier particles easily, which can easily cause toner filming on the surfaces thereof.

After years of dedicated research, the inventor of the present patent application measured adhesion forces of each particle of toner with respect to the surface of a developing roller and found that toner releasability of toner from the surface of the developing roller can be determined according to the measured adhesion forces.

### Example Embodiment 1

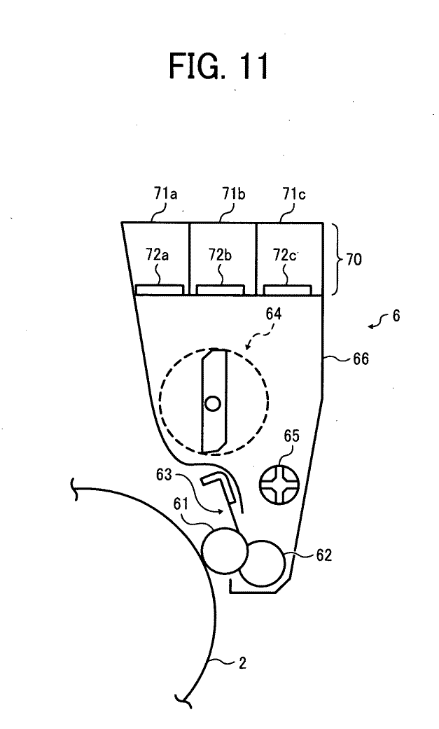

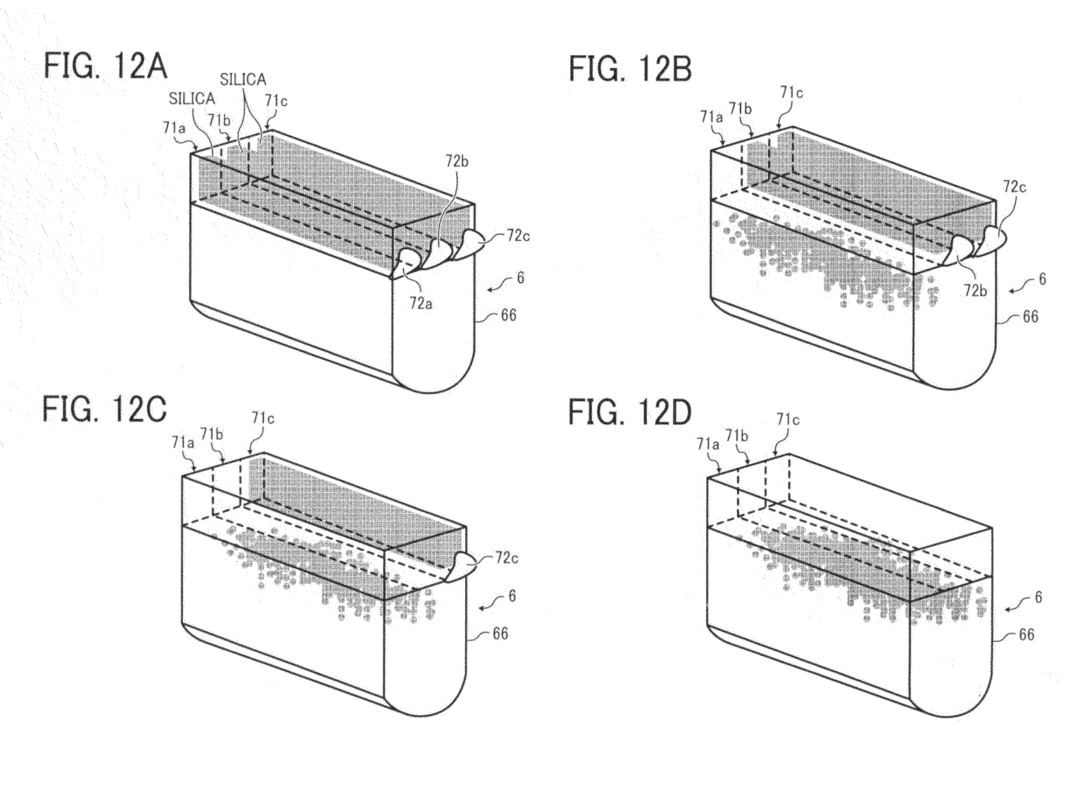

FIG. 11 illustrates an example of a developing unit 6 according to Example Embodiment 1 of the present patent application.

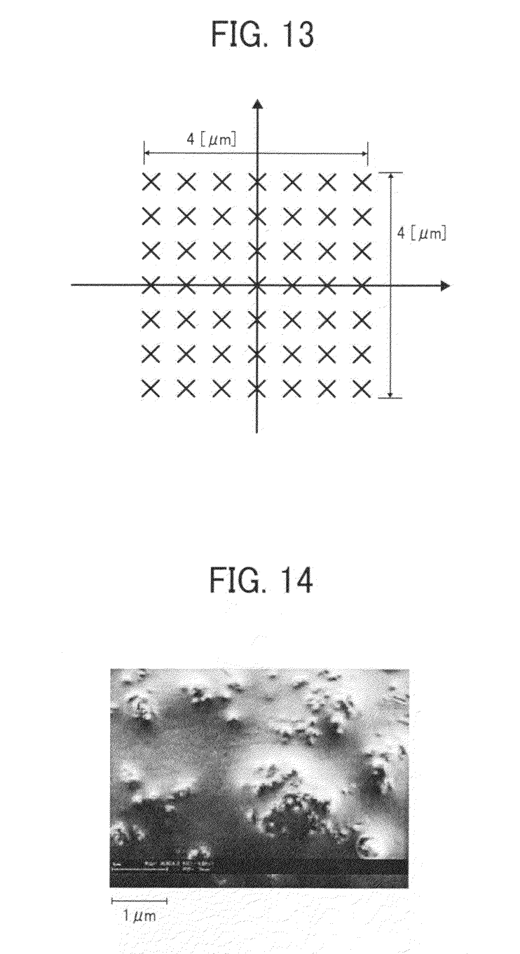

The developing unit 6 of FIG. 11 includes a silica supplying mechanism 70 that includes silica containers 71a, 71b, and 71c. The silica containers 71a, 71b, and 71c of the silica supplying mechanism 70 are disposed at the upper part of the developing unit 6, more particularly, atop the developer case 66 thereof, and communicate with the developer case 66 of the developing unit 6 via respective connecting holes, not illustrated. In FIG. 11, the connecting holes are closely blocked with seals 72a, 72b, and 72c. The seals 72a, 72b, and 72c are disposed partly protruding out of an exterior wall of the developer case 66 of the developing unit 6, as illustrated in FIG. 13A. When a user pinches the protruding part of the seals 72a, 72b, and 72c and pulls them out from the developing unit 6 one by one, the silica containers 71a, 71b, and 71c and the developer case 66 of the developing unit 6 can become communicated to supply silica particles contained in the silica containers 71a, 71b, and 71c into the developer case 66 of the developing unit 6 via the connecting holes.

In Example Embodiment 1, after a preset number of sheets have been output, the user pulls out each of the seals 72a, 72b, and 72c in the order as illustrated in FIGS. 13B, 13C, and 13D one by one. By so doing, silica particles are supplied from the silica containers 71a, 71b, and 71c to the developer case 66 of the developing unit 6.

The silica particles supplied into the toner particles in the developer case 66 of the developing unit 6 travel with the toner particles via an agitator 64 and a screw 65 that serves as a toner conveyer, for agitating and conveying toner particles and silica particles, a toner supply roller 62 serving as a particle supplying member for conveying and supplying agitated developer including the toner particles and the silica particles to the surface of a developing roller 61, and a toner regulating member 63, also referred to as a doctor blade 63 regulates the toner particles supplied on the surface of the developing roller 61 into a thin layer. It should be especially noted that the toner particles are agitated through the conveyance and the silica particles are mixed with the toner particles on the way to the developing roller 61, which can distribute the silica particles evenly with no space therebetween over the surface of the developing roller 61.

The key point of the present invention is to distribute nano-order particles, which are originally easily adherable to an object, evenly and without space therebetween over the surface of the developing roller 61. To enable the present invention, silica particles are supplied into toner particles to be mixed with the toner particles before the toner particles are agitated and conveyed.

To determine whether the method functions or not, it is significantly effective to measure adhesion force of each particle of toner by moving each toner particle in a grid-like pattern in a small area of four square micrometers [μm] across the surface of the developing roller 61, as described later. This measurement is effective because toner filming tends to occur even a small area on the surface of the developing roller 61 has poor toner releasability. By performing the measurement, it can be determined whether silica particles are evenly distributed over the surface of the developing roller 61 without any space therebetween so as to obtain good toner releasability over the surface of the developing roller 61.

Here, a description is given of how important to obtain a distribution of characteristic values of adhesion forces of each particle of toner on the surface of the developing roller, e.g., the developing roller 61, according to a measurement of adhesion forces of each toner particle to the developing roller 61.

Many of known measurement methods of adhesion forces of each particle of powder, i.e., toner, conduct a measurement of adhesion forces generated between a mass of powder and a target member. However, powder as a mass has distributions of particle diameter, shape, etc., and therefore it is difficult to maintain accuracy to repeatedly evaluate a distribution of the characteristic values of the surface of the target member.

For example, in a method of measuring adhesion forces of powder using a centrifugal force described in “M. Takeuchi, A. Onose, M. Anzai, R. Kojima and K. Kawai: Proc. IS&T 7th Int. Congress Adv. Non-Impact Printing Technology, 21991, vol. 1, pp. 200-208”, a sample substrate with a powder attached thereto is prepared to evaluate the centrifugal force to separate the powder from the sample substrate. However, according to the above-described reasons, this measuring method cannot determine a distribution of the characteristic values of the surface of a member. In the first embodiment, adhesion forces are measured with a constantly same particle, e.g., toner particle, so as to maintain accuracy to repeatedly determine a distribution of the adhesion forces of each particle of toner to the surface of the member.

The adhesion forces generated between each particle of toner with respect to the surface of the developing roller 61 are measured at multiple points on the surface of the developing roller 61, specifically, at 49 points (=7 points×7 points) in an area of 4 square micrometers (μm²), as shown in FIG. 13, for example. By measuring the adhesion forces of powder as described above, any part that has poor releasability can be detected.

These measurements of adhesion forces of each particle of powder can be conducted with an atomic force microscope or AFM, for example. A summary of the AFM and measurements of adhesion forces with the AFM is described below. However, the method of measuring adhesion forces generated between each particle of powder such as toner and a member such as the developing roller 61 is not limited to be conducted with the AFM. For example, a method of measuring adhesion forces of powder can be performed with an instrument or unit that can measure adhesion forces of powder at multiple points on a member. Alternatively, a method disclosed in Japanese Patent Laid-open Publication No. 2001-183289 can be applied, for example.

Principle of operation of the AFM is described in many public documents (for example, Appl. Phys. Lett., Vol. 56, No. 18, 30 Apr. 1990, Pages 1758-1759). A principle of operation of non-contact type AFM is described as follows: A cantilever with a tip of needle (probe chip or chip) having a surface made of substance such as silicon nitride, silicon dioxide attached thereto is used to scan a sample surface. The cantilever with the probe chip is brought close to a surface of a target sample to measure a force between the sample surface and the probe chip by the deflection of a laser light beam to a photodiode as curl or bend of the cantilever. Then, a signal based on the measurements is set to a feed back control so as to control a distance between the probe chip and the sample surface by piezo element.

When adhesion forces of powder or toner are measured using an AFM, the cantilever may need to be decorated. Specifically, target powder is attached to the tip of the cantilever by an adhesive such as epoxy resin by using a dedicated unit as disclosed in Japanese Patent Laid-open Publication No. 2002-062253 or by using the AFM.

Further, there are two methods of measuring adhesion force of powder or toner with an AFM.

A force curve measurement method or force-distance curve measurement method is an adhesion force measuring method in which a tip of a cantilever and a sample surface are contacted to each other and separated from each other continuously, so that adhesion forces between the cantilever and the sample surface can be obtained based on an amount of flexure of the cantilever on separation of the tip of the cantilever and the sample surface. (For example, Japanese Patent Laid-open Publication No. 2002-062253.)

The other method is pulsed-force-mode atomic force microscopy (PFM-AFM). The PFM-AFM is applied based on the force curve measurement (for example, Appl. Phys. Lett., Vol. 71, No. 18, 3 Nov. 1997, Pages 2632-2634).

While the concept of the force curve measurement is to measure one point, the PFM-AFM performs the force curve measurement in a two-dimensional region repeatedly. Specifically, while scanning the sample surface in a range of from approximately 0.1 Hz to approximately 10 Hz, a table with the sample thereon was vibrated in a vertical direction at approximately 100 Hz to approximately 1000 Hz. By so doing, the tip of the cantilever and the sample surface can contact with each other and separate from each other continuously.

It is preferable to evaluate the sample in measurement area conditions in a range of from 500 nm to 10,000 nm. While evaluating the distribution of the adhesion force, when the area is too small, local variance of the adhesion forces may affect significantly to obtain a standard deviation appropriate to determine based on the distribution of the adhesion forces. Accordingly, depending on an evaluation target, the measurement area condition is set to a range of 500 nm or greater.

Further, when the AMF is used as an adhesion force measurement unit, a significantly large area cannot be set. For example, the maximum settable area with the PFM-AFM is from some thousand nm to 10,000 nm. In addition, the AFM has a speed of movement of a sample table or a cantilever of some thousand nm/s at maximum. Therefore, it is not preferable to take a long measurement period for a significantly large area.

Further, it is preferable to measure 49 points in a square of 7 points×7 points as data for mapping distribution of adhesion force. It is highly likely to cause variance in data with measurement data of smaller than 49 points.

When the AMF is used as an adhesion force measurement unit, a significantly large number of data cannot be set. Therefore, it is preferable to measure smaller than 65,536 points in a square of 256 points×256 points.

[Test 1]

<Relation between the Amount of Silica Particles on the Surface of the Developing Roller and Toner Filming>

Following descriptions are given of adhesion force exerted over the surface of the developing roller 61 and the toner filming state thereon when silica particles are supplied over the surface of the developing roller 61. According to the test results, when silica is applied to the developer, the adhesion force exerted between the silica particles and the surface of the developing roller 61 can be reduced, which can contribute to a reduction or prevention in the toner filming on the surface of the developing roller 61.

[Summary of Test 1]
Machine: Modified IPSiO SP C220 (manufactured by Ricoh Company Ltd.); and
Output image: 6,000 sheets of a chart with 5% coverage of image area.

<Toner in Cartridge>
Type of toner: Pulverized toner particles containing wax, average particle diameter: 7 μm;
Additives: One part of silica particle having a diameter of 10 nm and two parts of silica particles having a diameter of 50 nm;
Amount of toner: 180 grams; and
Color of toner: Cyan.

<Developing Roller Condition>

A developing roller includes a core metal formed by aluminum having a diameter of 6 mm and an elastic rubber layer having a thickness of 3 mm. Further, to control the amount of toner on the surface of the developing roller, e.g., the developing roller 61, particles each having a diameter of approximately 20 μm and roughness are embedded in the surface of the developing roller 61 (Surface roughness Ra of the developing roller: 1.8 μm).

<Conditions of Silica to be Supplied to the Surface of a Developing Roller>
Type of silica: two different types, one having a diameter of 10 nm and the other having a diameter of 100 nm;
Amount of silica: two different amounts, 0.5 grams of silica particles having a diameter of 10 nm and 1.0 gram of silica particles having a diameter of 100 nm, are supplied each time 2,000 sheets are output; and
How to check distribution state of silica particles on the surface of a developing roller: After outputting 6,000 sheets, the surface of the developing roller, e.g., the developing roller 61, was examined with an electronic microscope under magnification of 20,000 times.

However, under the condition in which silica particles are not supplied from the silica supplying mechanism 70, the toner filming occurs on the surface of the developing roller 61. Therefore, regions where no toner filming has not yet occurred are selectively observed so as to grasp the direct condition of application of silica particles on the surface of the developing roller 61.

<Evaluation Condition of Adhesion of Toner to a Developing Roller>
Assessment method: Evaluated with an AFM by assessment method of adhesion force of toner. More specifically, after the image is output, the surface of the developing roller 61 was removed from the core metal, cut the surface into approximately 10 square millimeters, and measured the surface;
AFM: Scanning Probe Microscope SPI4000 and Multiple Function Unit and SPA400 (manufactured by SII Nano Technology Inc.);
Adhesion force measurement condition: Force curve method;
Measurement mode: Contact mode;
Cantilever: Standard-type silicon nitride cantilever OMCL-RC800PSA (manufactured by Olympus Corporation), Spring constant: 0.76 N/m;
Measurement area: 4 square μm;
Measurement Points: 49 points: 7 points in vertical direction and 7 points in horizontal direction;
Maximum Loading Conditions: Target pushing force of 50 nN of the tip of the cantilever onto the surface of a sample;
Toner Particle Diameter at Tip of Cantilever: 6.5 μm; and
Toner Type: Trial model PxP toner (manufactured by Ricoh Company Ltd.) with additives and trial model PxP toner (manufactured by Ricoh Company Ltd.) without additives.

<Developing Roller Filming Evaluation Condition>

The following show parameters and conditions of the test:
Assessment method: Evaluated, after output of 6,000 sheets, charging amount by observing through a laser microscope and suck-in method.

The assessment of charging amount was measured after driving the machine for one minute with the charging bias and development bias were applied. Further, to evaluate the deterioration condition of the developing roller 61 itself, unused parts other than the developing roller 61 and unused toner were employed.
Laser microscope: VK 8500 manufactured by Keyence Corporation (Magnification: ×25, ×50); and
Observed at three points, the center part and both axial end parts of a roller. Whether or not filming exists was determined by whether or not a color of toner used was transferred onto the surface of the developing roller 61.

Next, detailed descriptions are given of the results of Test 1, referring to FIGS. 14 through 16.

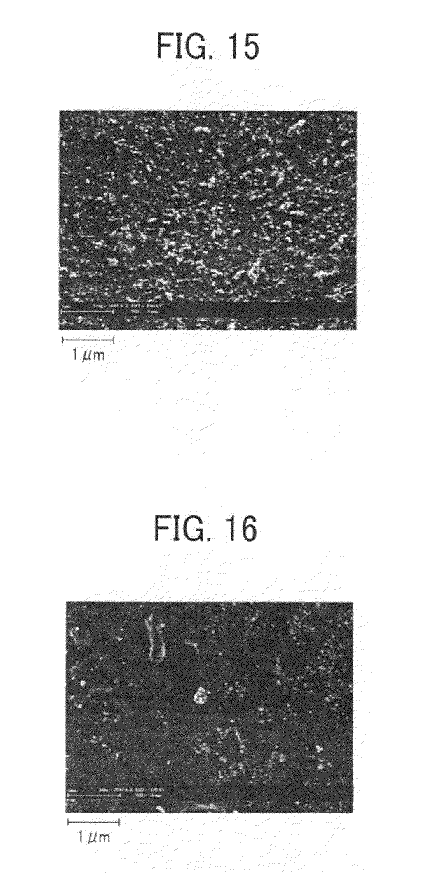

FIGS. 14 through 16 show that the present invention operates the silica supplying mechanism 70. More specifically, while the surface of an unused developing roller is basically flat except that there are charge control carbon particles scattered about thereon as illustrated in FIG. 14, silica particles are evenly and tightly arranged on the surface of the developing unit with the silica supplying mechanism 70 operated as illustrated in FIG. 15. Meanwhile, as illustrated in FIG. 16, even though silica particles that are detached or free from the toner particles still remain partly on the surface of the developing roller when silica particles are not supplied from the silica supplying mechanism 70, greater part of the surface of the developing unit is exposed.

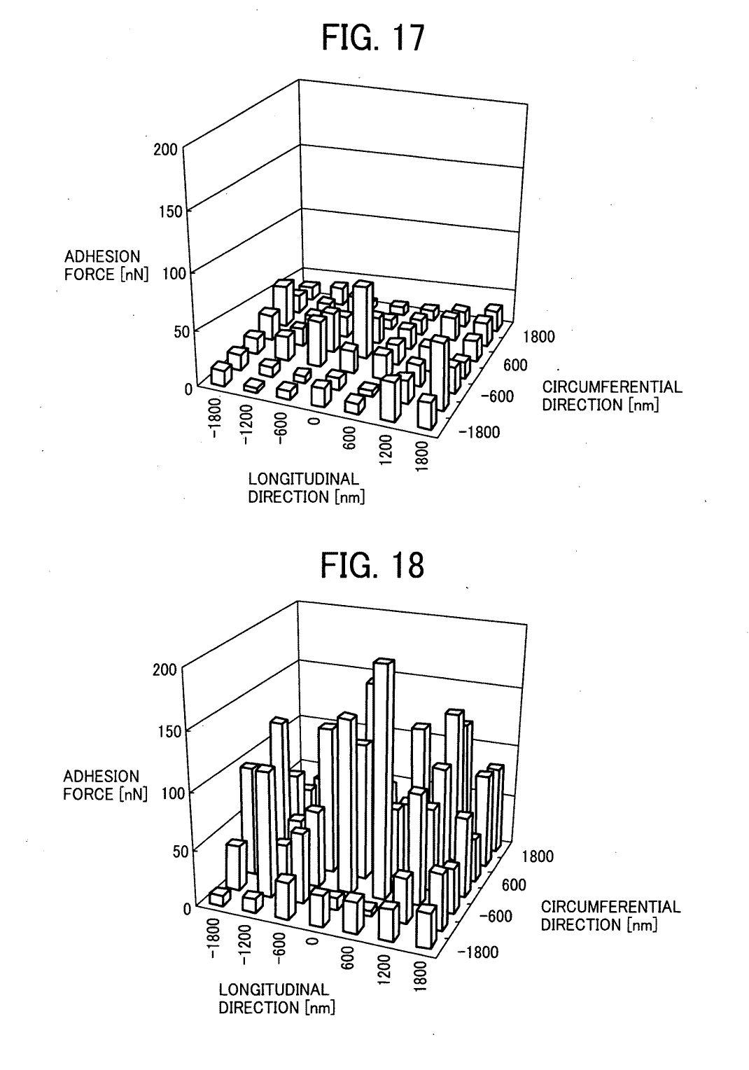

FIGS. 17, 18, and 19 show graphs indicating adhesion forces exerted on the surface of the developing roller 61 described above.

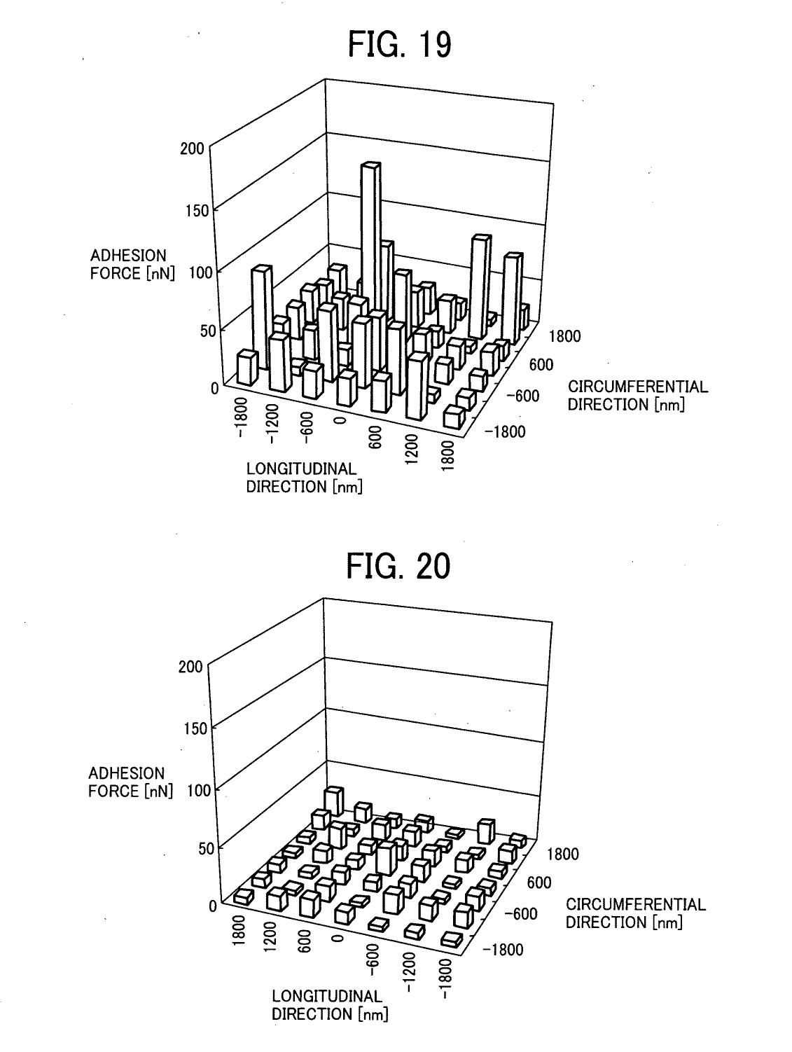

When silica particles are supplied from the silica supplying mechanism 70 to the developer case 66, the developing roller 61 has achieved a low adhesion force defined as that the adhesion force at each measurement point on the surface thereof is 100 nN or smaller, as illustrated in FIG. 17. By contrast, when silica particles are not supplied from the silica supplying mechanism 70, the developing roller 61 has large parts partly having an adhesion force of 100 nN or greater on the surface thereof, as shown in the graph of FIG. 19. As obviously seen from the measurement results of adhesion force exerted over the surface of the unused developing roller 61, shown in the graph of FIG. 18, the surface of the developing roller 61 used in this test includes material having an adhesion force of greater than 100 nN with respect to toner particles. Therefore, the material originally forming the surface of the developing roller 61 is exposed in an area having adhesion force of greater than 100 nN as indicated in the graph of FIG. 19.

Further, FIG. 20 illustrates measurement results of adhesion force exerted over the surface of the developing roller 61 with the silica supplying mechanism 70 operated to supply silica particles therefrom to the developer case 66, measured with a probe in which toner without external additives on the surface of the developing roller 61 is attached at the tip of the cantilever. When toner does not have external additives on the surface of the developing roller 61, the adhesion force of toner to the surface thereof can become significantly large. However, when silica particles are supplied from the silica supplying mechanism 70 to the developer case 66, the adhesion force exerted over the surface of the developing roller 61 can remain low even if such toner is used. When toner in the developing unit 6 are used for a long period of time, the external additives of toner can be buried in toner or peeled from toner and the toner filming can be caused easily. The graph of FIG. 20 shows that, even when such toner is contained in the developing unit 6, if silica particles are supplied from the silica supplying mechanism 70 to the developer case 66, the adhesion force between the surface of the developing roller 61 and each particle of toner can be reduced and the toner filming can be prevented.

Table 1 shows evaluation results of toner filming on the surface of the developing roller 61, evaluated when the silica supplying mechanism 70 is operated or when it is not operated.

TABLE 1

| | Silica Supplied | Silica Not Supplied |
|---|---|---|
| Toner Filming | Not Occurred | Occurred |
| Toner Charge Amount | −33.7 | −28.6 |
| [μC/g] | | |
| Toner Charge Amount | 95 | 81 |
| Reduction Ratio [%] | | |

When the silica supplying mechanism 70 was not operated and silica particles were not supplied therefrom to the developer case 66, toner resin having a diameter of some hundred μm adheres to the surface of the developing roller 61 in a sea island form. By contrast, when the silica supplying mechanism 70 was operated and silica particles were supplied therefrom to the developer case 66, no toner resin was found to be adhered to the surface of the developing roller 61 even though the surface of the developing roller 61 was partly scraped due to the action of deteriorated toner particles and the doctor blade 63. Further, when the silica supplying mechanism 70 is operated to supply silica particles thereto, a toner charging function, not illustrated, which performs an important function did not cause functional deterioration.

Further, to supply silica particles to the developer case 66 of the developing unit 6, this example embodiment employs a mechanism in which a user pulls out a seal or seals from the developer case 66 of the developing unit 6 manually. However, any other mechanism that is different from this mechanism can be employed. For example, this example embodiment can use a mechanism in which a shutter or other similar member automatically opens and closes a bottom face of the silica container.

Further, three silica containers are prepared for storing silica particles in this example embodiment. However, the number of silica containers and the amount of silica particles per container are not limited thereto.

Further, the configuration described in this example embodiment is applicable regardless of types of developing roller 61 included in the image forming apparatus 100. By arranging silica particles on the surface of the developing roller 61, the adhesion force exerted between the surface of the developing roller 61 and each particle of toner is determined by the amount and density of silica particles on the surface of the developing roller 61. That is, the adhesion force between the surface of the developing roller 61 and each particle of toner in an area where the amount of silica particles is smaller is not affected by types of material of the surface of the developing roller 61.

### Example Embodiment 2

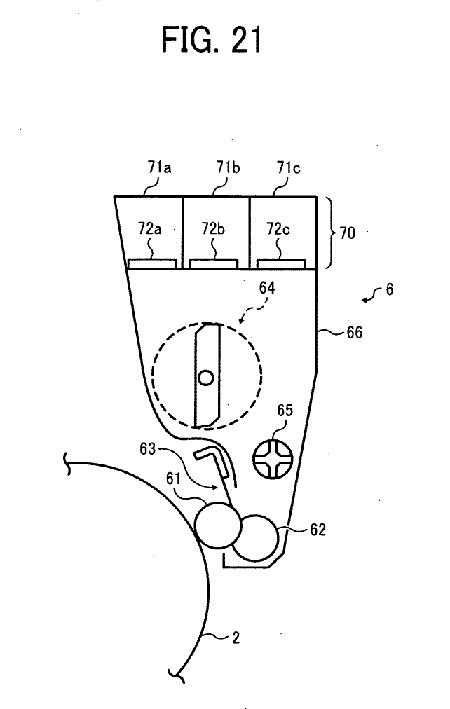

Example Embodiment 2 uses the developing unit 6 illustrated in FIG. 21 to reduce the adhesion force exerted over the surface of the developing roller 61 by supplying toner in the developing unit 6 to distribute silica attached to toner onto the surface of the developing roller 61.

[Test 2]

<Relation between the Amount of Silica on the Surface of the Developing Roller and Toner Filming>

(In a case in which silica is supplied on the surface of the developing roller 61 via toner)

[Summary of Test 2]
Machine: Modified IPSiO SP C220 (manufactured by Ricoh Company Ltd.); and
Output image: 3,000 sheets of a chart with 5% coverage of image area.

[Toner in Cartridge]
Type of toner: Pulverized toner particles containing wax, average particle diameter: 7 μm;
Additives: One part of silica particle having a diameter of 10 nm and two parts of silica particles having a diameter of 50 nm;
Amount of toner: 60 grams; and
Color of toner: Cyan.

<Conditions of Silica to be Supplied to the Surface of a Developing Roller>

By supplying toner under the following conditions into the cartridge every time 1,000 sheets are output, silica added to toner is supplied to the surface of the developing roller 61:
Type of toner: Pulverized toner particles containing wax, average particle diameter: 7 μm;
Additives: One part of silica particle having a diameter of 10 nm and two parts of silica particles having a diameter of 50 nm;
Amount of toner: 60 grams; and
Color of toner: Cyan.
How to check distribution state of silica particles on the surface of a developing roller: After outputting 3,000 sheets, the surface of the developing roller, e.g., the developing roller 61, was examined with an electronic microscope under magnification of 20,000 times.

However, under the condition in which silica particles were not supplied from the silica supplying mechanism 70 to the developer case 66, the toner filming were observed on the surface of the developing roller 61. Therefore, regions where no toner filming has not yet occurred are selectively observed so as to grasp the direct condition of application of silica particles on the surface of the developing roller 61.

[Evaluation Condition of Developing Roller Adhesion Force]
Assessment method: Evaluated with an AFM by assessment method of adhesion forces of toner. More specifically, after the image was output, the surface of the developing roller 61 was removed from the core metal, cut the surface into approximately 10 square millimeters, and measured the surface;
AFM: Scanning Probe Microscope SPI4000 and Multiple Function Unit and SPA400 (manufactured by SII Nano Technology Inc.);
Measurement mode: Contact mode;
Adhesion force measurement condition: Force curve method;
Cantilever: Standard-type silicon nitride cantilever OMCL-RC800PSA (manufactured by Olympus Corporation), Spring constant: 0.76 N/m;
Measurement area: 4 square μm;
Measurement Points: 49 points: 7 points in vertical direction and 7 points in horizontal direction;
Maximum Loading Conditions: Target pushing force of 50 nN of the tip of the cantilever onto the surface of a sample;
Toner Particle Diameter at Tip of Cantilever: 6.3 μm; and
Toner Type: Trial model PxP toner (manufactured by Ricoh Company Ltd.) with additives and trial model PxP toner (manufactured by Ricoh Company Ltd.) without additives.

<Developing Roller Filming Evaluation Condition>

The following show parameters and conditions of the test:
Assessment method: Evaluated, after output of 3,000 sheets, charging amount by observing through a laser microscope; and
Laser microscope: VK 8500 manufactured by Keyence Corporation (Magnification: ×25, ×50).

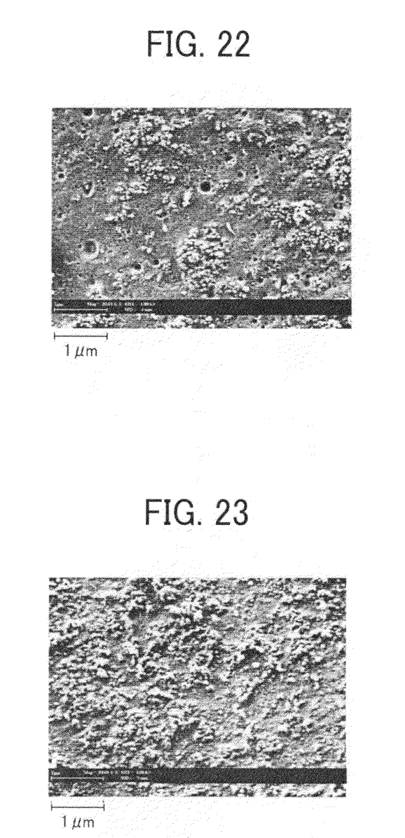

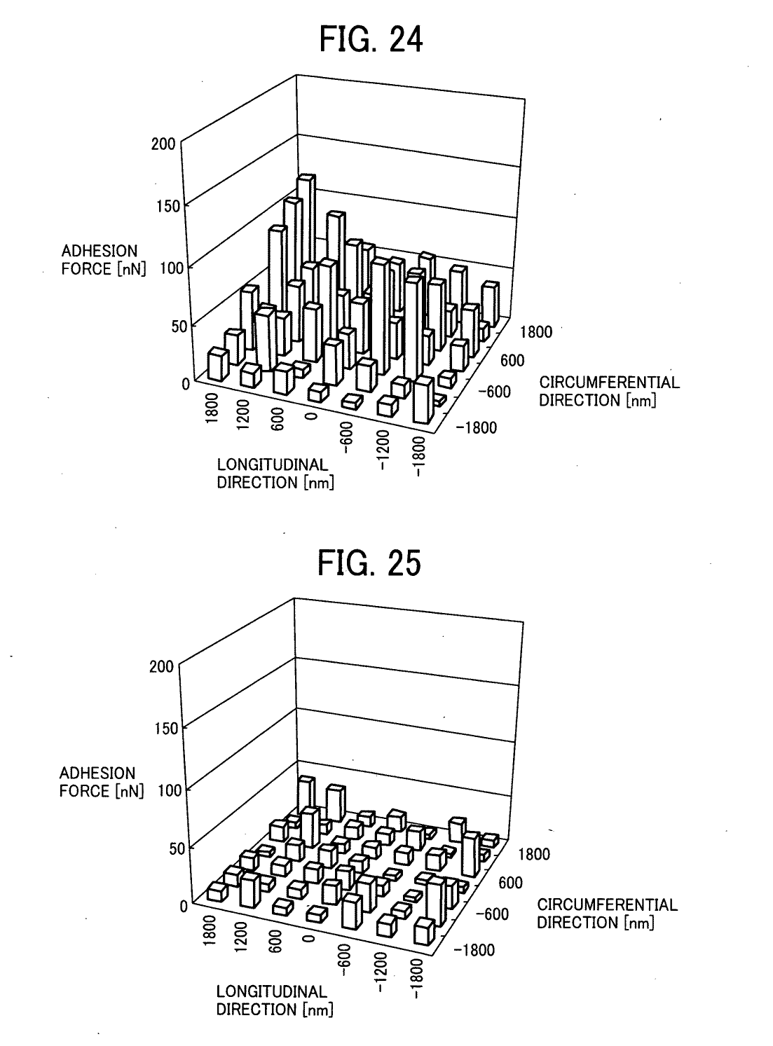

FIG. 22 is an image showing a surface state of the developing roller 61 when the silica supplying mechanism 70 is not operated and silica particles are supplied to the developer case 66. FIG. 23 is an image showing a surface state of the developing roller 61 when the silica supplying mechanism 70 is operated and silica particles are not supplied therefrom. Further, FIG. 24 is a graph showing measurement results of adhesion forces exerted on the surface of the developing roller 61 when the silica supplying mechanism 70 is not operated to supply the silica particles to the developer case 66. FIG. 25 is a graph showing measurement results of adhesion forces exerted on the surface of the developing roller 61 when the silica supplying mechanism 70 is operated and supplies the silica particles to the developer case 66.

The surface state of the developing roller 61 when the silica supplying mechanism 70 does not supply silica particles therefrom as shown in FIG. 22 and the surface state thereof when the silica supplying mechanism 70 supplies silica particles therefrom as shown in FIG. 23 are compared. The comparison shows that, as the image of FIG. 23, use of the silica supplying mechanism 70 can distribute silica particles on the surface of the developing roller 61 evenly with no space between the silica particles, even in the configuration of this example embodiment.

Further, when compared with the graph showing the measurement results of adhesion forces exerted on the surface of the developing roller 61 when the silica supplying mechanism 70 is not operated as shown in FIG. 24, the graph showing the measurement results of adhesion forces exerted on the surface of the developing roller 61 when the silica supplying mechanism 70 is operated as shown in FIG. 25 shows that the adhesion forces of toner the entire measurement points on the surface of the developing roller 61 can remain in a low level of 100 nN or below by supplying silica particles from the silica supplying mechanism 70 in the configuration of this example embodiment. As a result, in this example embodiment as shown in Table 2, when the silica supplying mechanism 70 was operated, toner filming on the surface of the developing roller 61 was prevented. That is, according to the measurement results obtained by Test 2, even if silica particles are supplied via toner particles, the adhesion forces exerted on the surface of the developing roller 61 can be maintained in a low level, which is conducive to a reduction or prevention of toner filming on the surface of a developing roller 61.

TABLE 2

| | Silica Supplied | Silica Not Supplied |
|---|---|---|
| Toner Filming | Not Occurred | Occurred |

The configuration in Example Embodiment 2 is effective that silica particles are mixed with toner particles in advance before being distributed onto the surface of the developing roller 61. Therefore, compared with Example Embodiment 1, Example Embodiment 2 includes a greater amount of silica particles or greater margins of toner conveyance conditions of the agitator 64, the screw 65, and the like.

Further, the concept of the configuration in Example Embodiment 2 is totally different from a conventional concept that new toner particles are replenished after the toner particles contained in the cartridge are completely used up. That is, toner particles are supplied simply to supply and distribute silica particles onto the surface of the developing roller 61. Therefore, the configuration of Example Embodiment 2 is sufficiently valid to any system in which toner particles are supplied even when the toner particles are left in the cartridge, if any conditions in other units show that the developing roller 61 is in a condition that toner filming occurs easily.

Further, in Example Embodiment 2, the amount of toner originally contained in the cartridge and the amount of silica added to toner to be supplied are set to be same. However, any amount other than these amounts can be applied to the present patent application. Specifically, the more space in the apparatus is reduced, the more the amount of silica in the toner to be replenished is contained. Generally, only a sufficient amount of silica particles are added to a toner particle to cover the surface thereof. However, since the target of the present invention is to obtain an effect in distribution of silica particles, it is also sufficiently valid to add an extra amount of silica particles to a toner particle.

Further, in Example Embodiments 1 and 2, to achieve low adhesion forces of toner to the surface of the developing roller 61, the silica supplying mechanism 70 is provided in the developing unit 6. However, the present invention can also be achieved by using a developing roller, e.g., the developing roller 61, having nanoparticles distributed on a surface layer thereof. When using such a developing roller or the developing roller 61, it is important that silica particles are distributed on the surface of the developing roller 61 evenly without any space therebetween. Whether the distribution of silica particles is adequate or not can be determined by measuring adhesion forces of each particle of toner to the surface of the developing roller 61 with an atomic force microscope (AFM) and by observing the surface of the developing roller 61 with an electric microscope (EM).

Further, in Example Embodiments 1 and 2, the developing unit 6 using one-component or single-component developer consisting essentially of toner has been explained. However, the present invention is not limited to but can also be applied to a developing unit using two-component developer. That is, when a developing unit using two-component developer is used, it is likely to easily cause toner resin to adhere to carrier particles, which can decrease an amount of toner charge, resulting in deterioration of image quality. Applying the present invention to such a developing unit using two-component developer can decrease the adhesion force exerted between carrier and toner, resulting in prevention of contamination on the surface of each particle of carrier and a reduction in toner charge amount.

Further, in Example Embodiments 1 and 2, silica is used as nanoparticles to achieve low adhesion force exerted over the surface of the developing roller 61 but is not limited thereto. The present invention can be applied with other nanometer-sized particles including titanium, alumina, cerium oxide, silicon carbide, and so forth.

Further, even though it is not specified, the lower limit of an adhesion force between each particle of toner and the surface of a developing roller, e.g., the developing roller 61, regularly exceeds 2 nN to 3 nN that is the adhesion force exerted between each particle of silica and the surface of the developing roller 61. This value corresponds to an adhesion force measured with a cantilever with no toner attached at the tip thereof because the diameter of the tip of the cantilever is 10 nN that is substantially equal to the diameter of a silica particle. For example, when a standard-type silicon nitride cantilever OMCL-RC800PSA (manufactured by Olympus Corporation) with spring constant of 0.05 N/m is used to measure adhesion forces of each particle of toner to the surface of the developing roller 61 used in Test 1, the above-described value can be obtained as a minimum value.

As described above in Example. Embodiments 1 and 2 in the present invention, toner filming can be effectively prevented, in other words, cannot be generated on the surface of the developing roller 61 to set an adhesion force exerted between the surface of the developing roller 61 and each particle of toner to 100 nN or smaller.

According to an example embodiment of the present patent application as described above, the developing unit 6 develops a latent image formed on the photoconductor 2 serving as an image carrier into a visible toner image with developer including toner. The developing roller 61 is included in the developing unit 6 to serve as a developer carrier to carry the developer on the surface thereof rotating in an endless manner. The developing roller 61 serving as a developer carrier is disposed facing the photoconductor 2. In the developing unit 2, an adhesion force exerted between the surface of the developing roller 61 and each particle of toner is 100 [nN] or smaller. As shown in the above-described test results, the developing unit 6 under this configuration can prevent toner filming to cause on the surface of the developing roller 61.

According to an example embodiment of the present patent application, it is desirable that the adhesion force is measured using an atomic force microscope or AFM as a measurement instrument because the AFM can measure adhesion forces over the entire surface of the developing roller 61 as it moves freely across the surface of the developing roller 61 to gradually change measurement positions of the adhesion forces.

Further, according to an example embodiment of the present patent application, the adhesion force is measured using the toner has no external additives on the surface of the toner particles of the toner. Therefore, even if the toner with no external additives and high adhesion force is used, toner filming causing on the surface of the developing roller 61 can be prevented.

Further, according to an example embodiment of the present patent application, the adhesion force is obtained as the AFM moves in a grid-like pattern across the surface of the developing roller 61 at measurement intervals of 1 μm or smaller.

Further, according to an example embodiment of the present patent application, the adhesion force is obtained using the toner having a diameter within a range of from 3 μm to 10 μm. Therefore, toner filming on the surface of the developing roller 61 can be prevented regardless of the diameter of each toner particle of the toner.

Further, according to an example embodiment of the present patent application, the developing roller 61 has a roughness of 1 μm or smaller in a vertical direction on the surface thereof, measured as a difference between highest and lowest elevations of the surface of the developing roller 61. Under this condition of the developing roller 61, the adhesion force exerted between the surface of the developing roller 61 and each particle of toner can be reduced.

Further, according to an example embodiment of the present patent application, multiple particles each having a diameter of 1 μm or smaller are distributed over the surface of the developing roller 61. Therefore, convex and concave portions having a vertical distance of 1 μm or smaller can be formed on the surface of the developing roller 61, which can reduce the adhesion force exerted between the surface of the developing roller 61 and each particle of toner.

Further, according to an example embodiment of the present patent application, the developing unit 6 further includes a supplementary particle supplier (e.g., the silica supplying mechanism 70) to supply supplementary particles each having a diameter of 1 μm or smaller to the surface of the developing roller 61. With this configuration, supplementary particles having the diameter of submicron or smaller can be mixed with the developer in the developing unit 6, and therefore can easily form small convex and concave portions on the surface of the developing roller 61 and the surface of each carrier particle. Further, even if the state of the surface of the developing roller 61 and the surface of the carrier particle deform with age, the small convex and concave portions can be formed again on the surface of the developing roller 61 and the surface of each carrier particle. Thus, the adhesion force that can be exerted between each particle of toner and the surface of the developing roller 61 and the surface of the carrier particle can be reduced.

Further according to an example embodiment of the present patent application, the developing unit 6 includes the developer case 66 serving as a developer container to contain the developer that is supplied to the developing roller 61 at the development area. The supplementary particle supplier supplies the supplementary particles having a diameter 1 μm or smaller to the developer case 66 so as to supply the supplementary particles to the surface of the developing roller 61 together with the developer. By mixing the supplementary particles with the toner of the developer, the supplementary particles can be distributed in the developer while the toner particles are conveyed to the surface of the developing roller 61. Further, when using two-component developer, carrier particles help the supplementary particles to be distributed in the developer while the developer is conveyed to the surface of the developing roller 61. Therefore, the supplementary particles are adequately distributed over the entire surface of the developing roller 61 and the entire surface of each carrier particle.

Further according to an example embodiment of the present patent application, the developer case 66 includes developer mixed in advance with particles each having a diameter of 1 μm or smaller and also serves as the supplementary particle supplier. Therefore, the developing unit 6 can be modified not vastly but with minor changes by depositing the supplementary particles on the surface of the developing roller 61 and the surface of each particle carrier using the external additives of the toner, resulting in a successful formation of small convex and concave portions on the surface of the developing roller 61 and the surface of each carrier particle.

Further according to an example embodiment of the present patent application, the supplementary particles having a diameter of 1 μm or smaller are inorganic particles, which can widen the scope of selection of materials of supplementary particles.

Further according to an example embodiment of the present patent application, the inorganic particles are silica particles. Silica is used as additives to the toner particles of the toner, and therefore does not cause any significant defects.

Further, according to an example embodiment of the present patent application, the supplementary particles having a diameter of 1 μm or smaller are resin particles. Since the resin particles have less polishing effect, the resin particles can prevent damage to units and components provided in the developing unit 6.

Further, according to an example embodiment of the present patent application, the image forming apparatus 100 includes the photoconductor 2 that serves as an image carrier to carry a latent image on a surface thereof, and the developing unit 6 having the features described above. Since the configuration is employed to the image forming apparatus 2, the image forming apparatus 2 can prevent toner filming that can cause on the surface of the developing roller 61, and therefore can prevent image nonuniformity and white streaks in a solid image. Accordingly, the image forming apparatus 2 can perform good image forming.

Further, according to an example embodiment of the present patent application, the image forming apparatus 100 is incorporated in an image forming system. With this configuration, the image forming apparatus 2 can prevent toner filming that can cause on the surface of the developing roller 61, and therefore can prevent image nonuniformity and white streaks in a solid image. Accordingly, the image forming apparatus 2 can perform good image forming.

The above-described example embodiments are illustrative, and numerous additional modifications and variations are possible in light of the above teachings. For example, elements and/or features of different illustrative and example embodiments herein may be combined with each other and/or substituted for each other within the scope of this disclosure. It is therefore to be understood that, the disclosure of this patent specification may be practiced otherwise than as specifically described herein.

Obviously, numerous modifications and variations of the present patent application are possible in light of the above teachings. It is therefore to be understood that, the invention may be practiced otherwise than as specifically described herein.

What is claimed is:

1. A developing unit, comprising:
a developer case to contain a developer including a toner therein;
an agitator to agitate the developer in the developer case;
a toner conveyer to convey the developer agitated by the agitator; and
a developer carrier disposed facing an image carrier at a development area located between the developer carrier and the image carrier to carry the agitated developer conveyed by the toner conveyer toward a surface thereof to develop a latent image formed on the image carrier into a toner image with the developer at the development area,
wherein an adhesion force exerted between the surface of the developer carrier and each particle of the toner is 100 nN or smaller.

2. The developing unit according to claim 1, wherein the adhesion force is measured using an atomic force microscope as a measurement instrument.

3. The developing unit according to claim 2, wherein the toner has no external additives on the surface of each particle of the toner.

4. The developing unit according to claim 2, wherein the adhesion force is obtained as the measurement instrument moves in a grid-like pattern across the surface of the developer carrier at measurement intervals of 1 μm or smaller.

5. The developing unit according to claim 2, wherein the adhesion force is obtained by using toner particles each having a diameter within a range of from 3 μm to 10 μm.

6. The developing unit according to claim 1, wherein the developer carrier has a roughness of 1 μm or smaller in a vertical direction on the surface thereof, measured as a difference between highest and lowest elevations of the surface of the developer carrier.

7. The developing unit according to claim 6, wherein multiple particles each having a diameter of 1 μm or smaller are distributed over the surface of the developer carrier.

8. The developing unit according to claim 1, further comprising a supplementary particle supplier disposed at an upper part thereof to contain supplementary particles each having a diameter of 1 μm or smaller to supply to the surface of the developer,
the supplementary particles agitated and mixed with the developer in the developing unit before being conveyed with the developer toward the surface of the developer carrier.

9. The developing unit according to claim 8, further comprising a developer container to contain the developer that is supplied to the developer carrier,
the supplementary particle supplier supplying the supplementary particles having a diameter 1 μm or smaller to the developer container so as to convey the supplementary particles to the surface of the developer carrier together with the developer.

10. The developing unit according to claim 9, wherein the developer container includes developer mixed in advance with particles each having a diameter of 1 μm or smaller,
the developing unit further comprising a developer supplying member to supply the developer to the development area,
the developer supplying member also serving as the supplementary particle supplier.

11. The developing unit according to claim 10, wherein the supplementary particle supplier further comprises a sealing member disposed between the supplementary particle supplier and the developer container to closely block the supplementary particles to travel via a connecting hole that is disposed between the supplementary particle supplier and the developer container,
the supplementary particle supplier communicating with the developer container via the connecting hole by pulling out a part of the sealing member partly protruding out of the developing unit.

12. The developing unit according to claim 1, wherein the supplementary particles having a diameter of 1 μm or smaller are inorganic particles.

13. The developing unit according to claim 12, wherein the inorganic particles are silica particles.

14. The developing unit according to claim 1, wherein the supplementary particles having a diameter of 1 μm or smaller are resin particles.

15. An image forming apparatus, comprising:
an image carrier to carry a latent image on a surface thereof; and
the developing unit according to claim 1.

16. An image forming system, comprising:
an image forming apparatus comprising an image carrier to carry a latent image on a surface thereof and a developing unit,
the developing unit comprising:
a developer case to contain a developer including
a toner therein;
an agitator to agitate the developer in the developer case;
a toner conveyer to convey the developer agitated by the agitator; and
a developer carrier disposed facing an image carrier at a development area located between the developer carrier and the image carrier to carry the agitated developer conveyed by the toner conveyer toward a surface thereof to develop a latent image formed on the image carrier into a toner image with the developer at the development area,
wherein an adhesion force exerted between the surface of the developer carrier and each particle of the toner is 100 nN or smaller.

17. The image forming system according to claim 16, further comprising a supplementary particle supplier disposed at an upper part thereof to contain supplementary particles each having a diameter of 1 μm or smaller to supply to the surface of the developer,
the supplementary particles agitated and mixed with the developer in the developing unit before being conveyed with the developer toward the surface of the developer carrier.

18. The image forming system according to claim 17, further comprising a developer container to contain the developer that is supplied to the developer carrier,
the supplementary particle supplier supplying the supplementary particles having a diameter 1 μm or smaller to the developer container so as to convey the supplementary particles to the surface of the developer carrier together with the developer.

19. The image forming system according to claim 18, wherein the developer container includes developer mixed in advance with particles each having a diameter of 1 μm or smaller,
the developing unit further comprising a developer supplying member to supply the developer to the development area,
the developer supplying member also serving as the supplementary particle supplier.

20. The image forming system according to claim 19, wherein the supplementary particle supplier further comprises a sealing member disposed between the supplementary particle supplier and the developer container to closely block the supplementary particles to travel via a connecting hole that is disposed between the supplementary particle supplier and the developer container,
the supplementary particle supplier communicating with the developer container via the connecting hole by pulling out a part of the sealing member partly protruding out of the developing unit.
